(19) United States
(12) Patent Application Publication
(10) Pub. No.: US 2004/0160635 A1
(43) Pub. Date: Aug. 19, 2004

(54) Imaging apparatus and image processing apparatus

(75) Inventors: Hiroshi Ikeda, Osaka (JP); Takumi Hasebe, Wakayama (JP); Kazutaka Nishio, Osaka (JP)

Correspondence Address: McDERMOTT, WILL & EMERY, 600 13th Street, N.W., Washington, DC, 20005-3096, US

(73) Assignee: Matsushita Electric Industrial Co., Ltd.

(21) Appl. No.: 10/778,132

(22) Filed: Feb. 17, 2004

(30) Foreign Application Priority Data
Feb. 17, 2003 (JP) 2003-038178

(51) Int. Cl. G06F 15/00; H04N 1/40

(52) U.S. Cl. 358/1.15; 358/401

(57) ABSTRACT

The invention provides an imaging apparatus that when recording image data that includes an object, associates metadata for that object with the image data. The imaging apparatus comprises: an imaging unit that takes images of an object; a receiving unit that receives an object signal from the outside; and a judgment unit that determines whether or not the transmitter that transmits the object signal is included in the image when an object signal is received by the receiving unit; and when the judgment unit determines that the transmitter is included in the image, a recording unit records the information related to the transmitter, with the image data with which the information is associated, on a recording medium.

### BACKGROUND OF THE INVENTION

1. Field of the Invention

This invention relates to an imaging apparatus that takes images of objects, and an image-processing apparatus that processes the data of the images.

2. Description of the Related Art

In recent years, digitization of image data has advanced, and it has become possible to store and manage image data of images taken of an object with an imaging apparatus such as a digital still camera or digital video camera in a memory apparatus such as a hard disc. On the other hand, in recent years, the capacity of memory apparatuses such as a hard disc has increased, and the amount of data that can be stored in a memory apparatus has greatly increased. Therefore, it is becoming more and more difficult for the user to quickly find and obtain desired image data from among the large amount of data stored in the memory apparatus, and thus improvement of a search function for image data is desired.

In order to improve that kind of search function, it is necessary to store information for searching the image data desired by the user, in connection with the data of images taken of the objects with the imaging apparatus (hereafter, this information will be referred to as ‘metadata’), in the memory apparatus.

It is not impossible for the user to manually add metadata to each individual image data and store the image data in the memory apparatus in connection with the corresponding image data, however, it take a lot of time and work. Therefore, a means that allows the user to add metadata to image data without being troublesome is desired, and that kind of means has partially been realized. For example, the imaging apparatus records the date and time, place, and object on a recording medium as necessary metadata for searching for that image data, with associated with the corresponding image data.

For example, by constructing the imaging apparatus such that it has a clock function, when recording the image data obtained with that imaging apparatus on a memory apparatus such as a memory card, the date and time obtained from that clock function is recorded on the recording medium, with associated with that image data.

Moreover, as disclosed in Japanese unexamined patent publication No. 2001-169164, the imaging apparatus is constructed such that it has a location-identification function that uses GPS (Global Positioning System) or PCS (Personal Communication Services) to identify its location, and the image location that is obtained from that location-identification function is recorded on the recording medium, with associated with the image data.

Also, as disclosed in Japanese unexamined patent publication No. 2001-169164 and Japanese unexamined patent publication No. H10-13720, the imaging apparatus may have a location-identification function that identifies its own location with the name of the object stored together with that location (by using an installed electronic map, for example). That imaging apparatus estimates the location of the object and identifies that object, based on the location of the imaging apparatus identified by the location-identification function and the direction and amount of zoom used by the imaging apparatus when the imaging apparatus took images of the object, and records the name of that object on the recording medium with associated with the obtained image data.

In the prior art described above, the date and time of the image is used as metadata, and it is possible to search for desired image data from that date and time, however, it is not possible to identify the place or the object of the image. Furthermore, when the object is a stationary object, it is possible to identify the object by using an electronic map, however, when the location of the object moves, as in the case of a person, or when the object is not given on an electronic map, the imaging apparatus is able to estimate the location of the object based on its own position that is identified by the location-identification function and the direction and amount of zoom (imaging range), however it is not able to identify the name of the object. Therefore, the imaging apparatus is not able to obtain metadata for the object, and thus corresponding to a search becomes difficult.

### SUMMARY OF THE INVENTION

Therefore, taking into consideration the problem described above, the object of this invention is to provide an apparatus that is capable of correlating metadata for the object with the image data when recording image data that includes the object, even though the object is not given on an electronic map.

Moreover, another object of the invention is to provide an image-processing apparatus that is able to use that metadata to search for image data.

By using the imaging apparatus and image-processing apparatus of this invention, desired image data is search for by recording the metadata of the image data that contains the object on a specified recording medium together with that image data even when the location of the object moves as in the case of a person, or when the object is not given on an electronic map. However, there is a possibility that in the image found based on the searched data, the object will be blurred, or the object will be on edge of the image, or the size will be small, or the object will be dark due to images being taken against back lighting, or the contrast will be small. In that case, when the image found based on the searched image data is displayed on a specified display apparatus, it will be difficult for the user to see the object.

Therefore, taking that problem into consideration, a further object of the invention is to provide an imaging apparatus that takes images of an object or processes obtained image data such that it is easy for the user to see the object when the image found based on the image data containing the object is displayed.

In order to solve the problem above and accomplish the object of the invention, the imaging apparatus of this invention comprises: an imaging unit; a recording unit that records image data of images taken of an object by the imaging unit on a specified recording medium; a receiving unit that receives an object signal from the outside; and a judgment unit that determines whether or not the location of the source that sends the object signal is included in the image obtained by the imaging unit when the receiving unit receives the object signal. In addition, in the imaging apparatus of this invention, when the judgment unit determines that the location is included, the recording unit records the object information included in the object signal with associated with the image data on the recording medium.

Also, the image-processing apparatus of this invention performs processing on the image data recorded on the recording medium by the imaging apparatus. The image-processing apparatus uses the object information to search for specified image data when performing image processing on image data that is specified from the outside, of the image data recorded on the recording medium. Since searching is performed using object information that is associated with the image data, the time for searching for image data by the image-processing apparatus is shortened.

As can be clearly seen from the explanation above, the present invention makes it possible to associate metadata for an object with that image data when recording image data containing that object, even though that object is not given on an electronic map.

### BRIEF DESCRIPTION OF THE DRAWINGS

FIG. 1 is a block diagram of the imaging apparatus of a first embodiment of the invention.

FIG. 2 is a diagram shown the operating procedure of the imaging apparatus of the first embodiment of the invention.

FIG. 3 is an external view of the imaging apparatus of the first embodiment of the invention.

FIGS. 4A and 4B are drawings explaining the judgment method performed by the judgment unit of the imaging apparatus of the first embodiment of the invention.

FIGS. 5A and 5B are drawings explaining the judgment method performed by the judgment unit of the imaging apparatus of the first embodiment of the invention.

FIGS. 6A and 6B are drawings showing the positional relationship between the imaging apparatus and transmitter of the first embodiment of the invention.

FIG. 7 is a drawing for explaining the method of identifying the size of the object in the image obtained by the imaging apparatus of the first embodiment of the invention.

FIG. 8 is a drawing showing the range of the object in the image obtained by the imaging apparatus of the first embodiment of the invention.

FIG. 9 is a drawing showing an example of images of a moving image that was obtained by the imaging apparatus of the first embodiment of the invention.

FIG. 10 is a drawing showing an example of the recorded information that is associated with the moving image obtained by the imaging apparatus of the first embodiment of the invention.

FIG. 11 is a drawing showing the relationship among the imaging apparatus, transmitter and relay of the first embodiment of the invention.

FIG. 12 is a block diagram of the imaging apparatus of the first embodiment of the invention.

FIG. 13 is a block diagram of the imaging apparatus of the first embodiment of the invention.

FIG. 14 is a block diagram of the imaging apparatus of the first embodiment of the invention.

FIG. 15 is a block diagram of the imaging apparatus of the first embodiment of the invention.

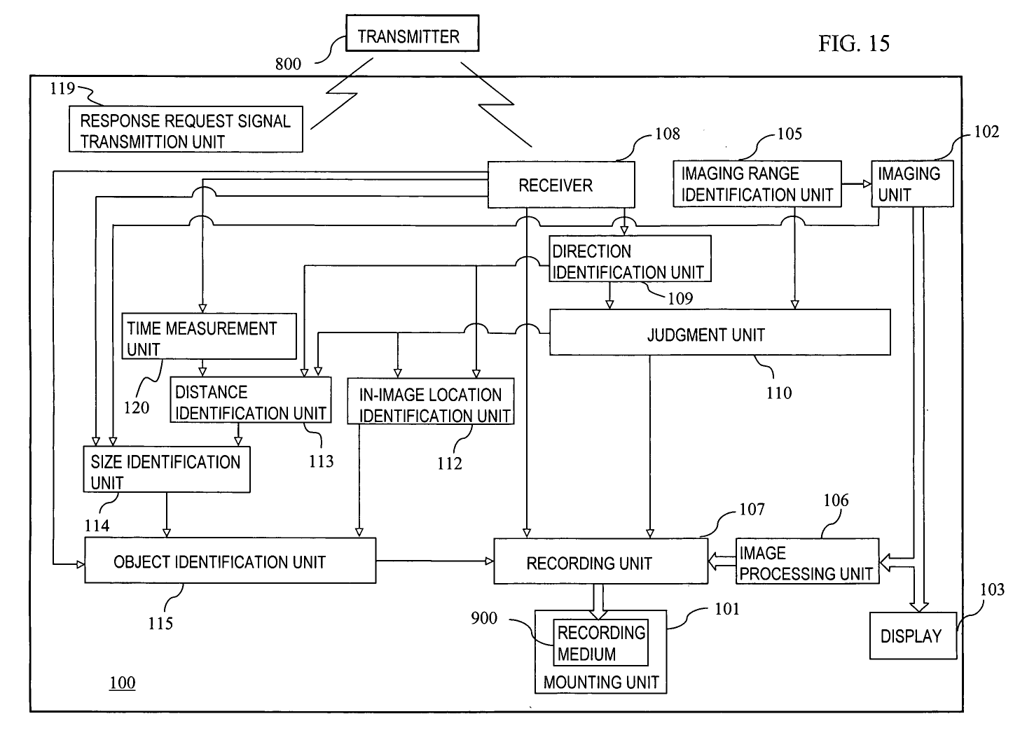

FIGS. 16A and 16B are drawings explaining the judgment method performed by the judgment unit of the imaging apparatus of the first embodiment of the invention.

FIG. 17 is a drawing showing an example of the images of a moving image obtained by the imaging apparatus of the first embodiment of the invention.

FIG. 18 is a drawing showing an example of the recorded information that is associated with the moving image obtained by the imaging apparatus of the first embodiment of the invention.

FIG. 19 is a block diagram of the image-processing apparatus of a second embodiment of the invention.

FIG. 20 is a drawing showing the operating procedure of the image-processing apparatus of the second embodiment of the invention.

FIG. 21 is a drawing explaining the case when an image is displayed based on image data that is processed by the image-processing apparatus of the second embodiment of the invention.

FIG. 22 is a drawing showing the operating procedure of the image-processing apparatus of the second embodiment of the invention.

FIG. 23 is a drawing explaining the case when an image is displayed based on image data that is processed by the image-processing apparatus of the second embodiment of the invention.

FIG. 24 is a drawing showing the operating procedure of the image-processing apparatus of the second embodiment of the invention.

FIG. 25 is a drawing explaining the case when an image is displayed based on image data that is processed by the image-processing apparatus of the second embodiment of the invention.

FIG. 26 is a drawing showing the operating procedure of the image-processing apparatus of the second embodiment of the invention.

FIG. 27 is a drawing explaining the case when an image is displayed based on image data that is processed by the image-processing apparatus of the second embodiment of the invention.

FIG. 28 is a drawing showing the operating procedure of the image-processing apparatus of the second embodiment of the invention.

FIGS. 29A and 29B are drawings explaining the contrast adjustment performed by the image-processing apparatus of the second embodiment of the invention.

FIGS. 30A and 30B are drawings explaining the contrast adjustment performed by the image-processing apparatus of the second embodiment of the invention.

FIG. 31 is a drawing explaining the condition when two imaging apparatuses take images of the same object, in the second embodiment of the invention.

FIGS. 32A to 32C are drawings explaining images obtained when two imaging apparatuses take images of the same object, in the second embodiment of the invention.

FIG. 33 is a block diagram of the imaging apparatus of a third embodiment of the invention.

FIG. 34 is a drawing showing the operating procedure of the imaging apparatus of the third embodiment of the invention.

FIG. 35 is a drawing showing the operating procedure of the imaging apparatus of the third embodiment of the invention.

FIG. 36 is a drawing showing the operating procedure of the imaging apparatus of the third embodiment of the invention.

FIG. 37 is a drawing showing the operating procedure of the imaging apparatus of the third embodiment of the invention.

FIG. 38 is a drawing showing the operating procedure of the imaging apparatus of the third embodiment of the invention.

FIG. 39 is a drawing showing the operating procedure of the imaging apparatus of the third embodiment of the invention.

FIG. 40 is a drawing showing the connection configuration of the image-distribution system of a fourth embodiment of the invention.

### DESCRIPTION OF THE PREFERRED EMBODIMENTS

The preferred embodiments of the invention will be explained below with reference to the drawings.

### First Embodiment

The construction and operation of an imaging apparatus 100 of a first embodiment of the invention is explained below.

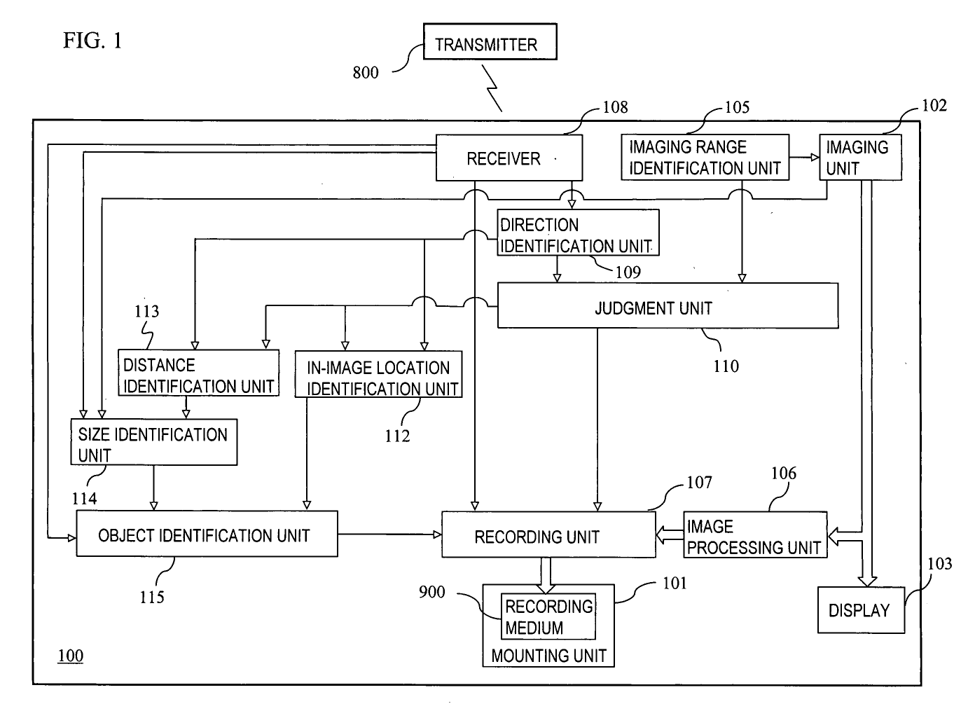

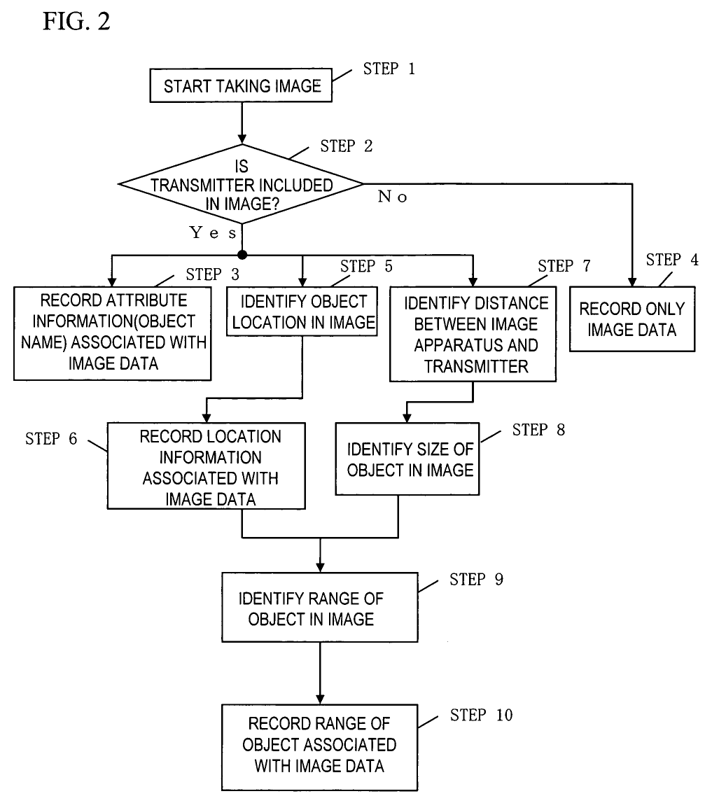

FIG. 1 is a block diagram of the imaging apparatus of a first embodiment of the invention, and FIG. 2 is a drawing showing the operating procedure of the imaging apparatus 100 shown in FIG. 2.

In this first embodiment of the invention, in order to simplify the explanation, it will be assumed that the imaging apparatus 100 is a portable video camera for obtaining moving images, and the user of the imaging apparatus 100 is a parent of a child attending a kindergarten, and that user is using the imaging apparatus 100 to take images of the child at a sports festival being held at the kindergarten. Also, in this first embodiment, that child is taken to be the object S, and a transmitter 800 that uses infrared rays to constantly transmit object information for identifying the name of the object (child) S as an object signal is attached to the object (child) S.

The user holds the imaging apparatus 100 that has a removable memory medium 900 such as a SD (Secure Digital) card or optical disc mounted in the mounting unit 101, an faces the external lens (not shown in the figure) toward the object S and presses a display button (not shown in the figure) that is located on the body of the imaging apparatus 100.

By doing this, the imaging unit 102 starts taking images (FIG. 2; step 1), and a display 103, such as a liquid-crystal display, displays the moving images obtained from the imaging unit 102. In order to set the amount of zoom (imaging range) used when the imaging unit 102 takes images of the object S, the user turns a zoom-selection dial (not shown in the figure) that is located on the body of the imaging apparatus 100 while looking at the moving images displayed by the display 103.

An imaging-range-identification unit 105 identifies the amount of zoom (imaging range) based on an imaging-range-calculation equation used for calculating the amount of zoom (imaging range) from the amount that the zoom-selection dial is turned. The imaging unit 102 takes images of the object S using the amount of zoom (imaging range) that was identified by imaging-range-identification unit 105.

When setting the amount of zoom (imaging range), the user presses the record button (not shown in the figure) located on the body of the imaging apparatus 100. By doing this, an image-processing unit 106 uses a specified compression method, such as the MPEG standard, to perform image processing on the image data of the moving-image data obtained from the imaging unit 102. A recording unit 107 records the image data that was processed by the image-processing unit 106 on the recording medium 900.

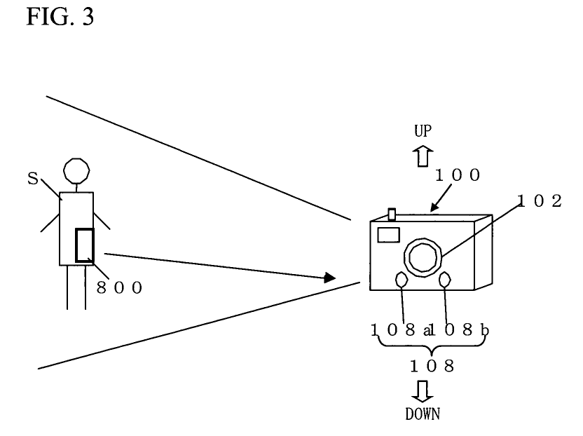

As shown in FIG. 3, there is a receiver 108 located on the imaging apparatus 100 that receives the object signal from the transmitter 800 attached to the object S or a location corresponding to the object (hereafter, simply referred to as the object S). There are two receiving sensors 108a, 108b, which are located on the receiver 108 at places on the front of the imaging apparatus 100 that are horizontal with respect to the imaging axis of the imaging apparatus 100 (or they may be located at places vertical with respect to the imaging axis), that receive the object signal. After receiving the object signal, the receiver 108 transfers the object information that was sent in the object signal to the recording unit 107.

Based on the object signal received by the receiving sensor 108a and receiving sensor 108b, a direction-identification unit 109 identifies the direction of the transmitting source of the object signal with respect to the imaging apparatus 100, or in other words, identifies the incident angle of the object signal with respect to the imaging apparatus.

Next, a judgment unit 110 determines whether or not the transmitter 800 is included in the image data obtained by the imaging unit 102 based on the imaging range identified by the imaging-range-identification unit 105 when the imaging unit 102 takes images of the object S and the incident angle of the object that was identified by the direction-identification unit 109 (FIG. 2; step 2).

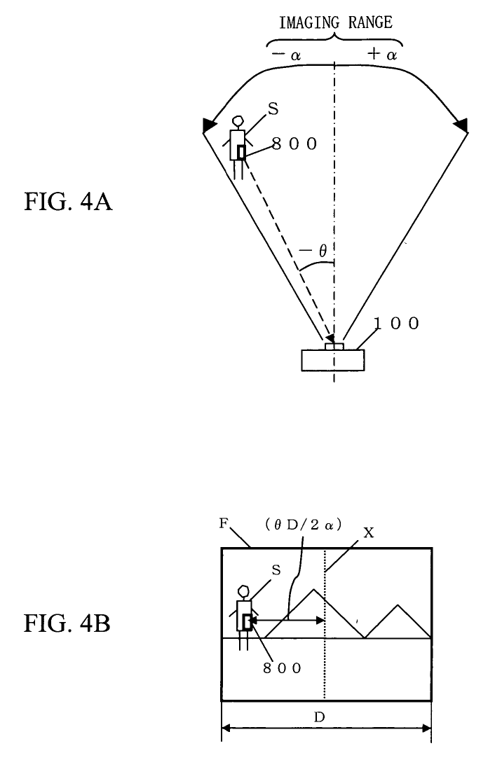

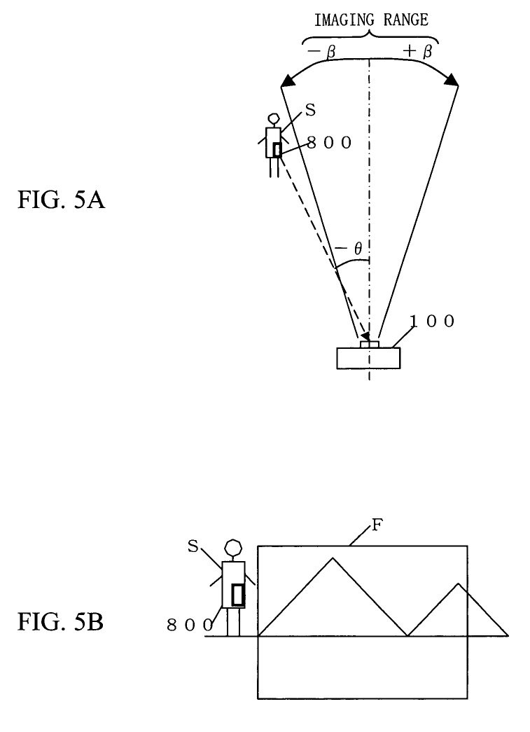

Here, the judgment method performed by the judgment unit 110 will be explained in detail using FIGS. 4A and 4B and FIGS. 5A and 5B.

FIG. 4A shows the condition where the amount of zoom is normal, the imaging range in the horizontal direction is −α to +α (where α is a positive value), and the incident angle of the object signal with respect to the imagining apparatus 100 in the horizontal direction is −θ to +θ (where θ is a positive value). In that case, when the incident angle of the object signal with respect to the imaging apparatus 100 in the vertical direction is in the imaging range, then, as shown in FIG. 4B, according to the image data taken and obtained by the imaging unit 102, the transmitter 800 (location of the transmitter) was included in the image F when the receiver 108 received the object signal.

In FIG. 5A, the location of the transmitter 800 is that same as that shown in FIG. 4A, however, the amount of zoom is more than in the case shown in FIG. 4A, or in other words, the imaging range in the horizontal direction is −β to +β (where β is a positive value, and β<α), which is narrower than the normal range of −α to +α. The incident angle −θ is outside the range −β to +β.

In this case, while the incident angle −θ is outside the range −β to +β, the incident angle of the object signal in the vertical direction is inside the range. As shown in FIG. 5B, the transmitter 800 is not included in the image F.

Therefore, the judgment unit 110 determines that the transmitter 800 (object S) is included in the image F when the incident angle of the object signal is within the imaging range identified by the imaging range identification unit 105 for both the horizontal direction and vertical direction (FIG. 2; step 2).

When the incident angle of the object signal does not fit within the imaging range, the judgment unit 110 determines that the transmitter 800 (object S) is not included in the image F (FIG. 2; step 2) When the judgment unit 110 determines that the transmitter 800 is ‘included’ in the image F, then the recording unit 107 records the object information with associated with the image data obtained by the imaging unit 102 as attribute information on the recording medium 900 (FIG. 2; step 3).

As a result, when the image-processing apparatus explained in the second embodiment processes the image data, it is possible to use the attribute information to search for image data in which the object S is included.

On the other hand, when the judgment unit 110 determines that the transmitter 800 (object S) is not included in the image F, the recording unit 107 only records the image data on the recording medium 900 (FIG. 2; step 4).

When the judgment unit 110 determined that the transmitter 800 is included in the image F, the in-image-location-identification unit 112 identifies the location of the object D in the image F based on the imaging range and incident angle of the object signal (FIG. 2; step 5).

Here, FIG. 4A will be used to explain in detail an example of the method performed by the in-image location identification unit 112 for identifying the location.

First, the in-image-location-identification unit 112 identifies whether the incident angle of the object signal in the horizontal direction is a positive value or a negative value. When the in-image location identification unit 112 identifies that the incident angle is a positive value, it determines that the transmitter 800 is located on the right side of the center X of the image F, and when it identifies that the incident angle is a negative value, it determines that the transmitter 800 is located on the left side of the center X of the image F. In the example shown in FIG. 4A, the incident angle is a negative value −θ, so the in-image location identification unit 112 determines that the transmitter 800 is located on the left side of the image F.

Next, the in-image-location-identification unit 112 divides the value of the incident angle by ½ the imaging range in the horizontal direction, and multiplies the absolute value of the value obtained from that calculation by ½ the length in the horizontal direction of the image F. In the example shown in FIG. 4A, the in-image-location-identification unit 112 divides the incident angle −θ by ½ the imaging range in the horizontal direction −α to +α to obtain the value (−θ/α), then multiplies the absolute value of that value (−θ/α) by ½ the length in the horizontal direction of the image (D/2). By doing this, the distance from the center X in the horizontal direction of the obtained image F to the transmitter 800 (θD/2α) is obtained.

As a result, the in-image-location-identification unit 112 identifies the location of the transmitter 800 (object S) in the horizontal direction of the image F. Similarly, the in-image-location-identification unit 112 identifies the location of the transmitter 800 (object S) in the vertical direction of the image F.

After the location of the transmitter 800 (object S) in the image F has been identified, the recording unit 107 records that location information with associated with the image data corresponding to the image F as location information on the recording medium 900 (FIG. 2; step 6).

When the judgment unit 110 determines that the transmitter 800 is included in the image F, a distance-identification 113 identifies the distance between the imaging apparatus 100 and the transmitter 800 based on the incident angle of the object signal received by the receiving sensors 108a, 108b (FIG. 2; step 7).

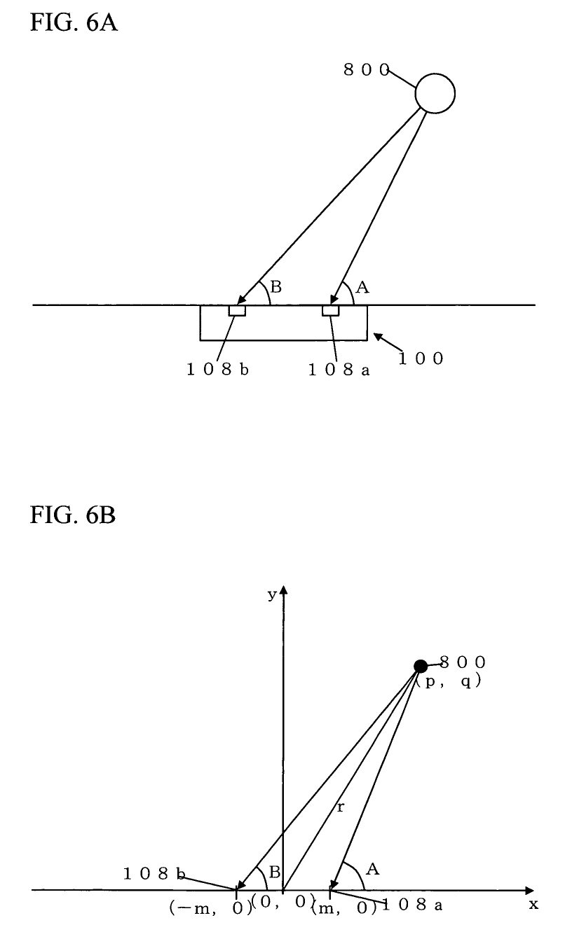

For example, when the positional relationship between the imaging apparatus 100 and transmitter 800 is a relationship as shown in FIG. 6A, the incident angle of the object signal received by the receiving sensor 108a is A, and the incident angle of the object signal received by receiving sensor 108b is B. In this case, the locations of the receiving sensors 108a, 108b shown in FIG. 6A and the location of the transmitter 800 are as shown in FIG. 6B when planar coordinates are used. For example, the coordinates of the locations of the receiving sensors 108a, 108b are (m, 0) and (−m, 0) (where m is a positive value), and the coordinates of the location of the transmitter 800 are (p, q). Here, the distance r from the center coordinates (0, 0) to the location (p. q) of the transmitter 800 is the distance between the imaging apparatus and the transmitter 800.

Therefore, by expressing tan A, tan B and r using p, q and m, the following equations 1 to 3 below are obtained.

$$\begin{matrix}tan A = \frac{q}{p - m} & [ Equation 1 ] \\ tan B = \frac{q}{p + m} & [ Equation 2 ] \\ r = \sqrt{{p}^{2} + {q}^{2}} & [ Equation 3 ]\end{matrix}$$

Therefore, by expressing r using A, B and m, the following equation 4 is obtained.

$$r = \frac{\sqrt{{( tan A + tan B )}^{2} + {( 2 tan A \times tan B )}^{2}}}{\vert tan A - tan B \vert} \qquad [ Equation 4 ]$$

Here, the distance-identification unit 113 identifies the distance between the imaging apparatus 100 and the transmitter 800 by substituting A, which is the incident angle of the object signal received by the receiving sensor 108a, B, which is the incident angle of the object signal received by the receiving sensor 108b, and m, which is ½ the distance between the receiving sensor 108a and receiving sensor 108b, into equation 4 above.

After the distance is detected, the size-identification unit 114 identifies the size of the object S in the image F based on the identified distance, the focal distance when the imaging unit 102 took the image of the object S, and the actual size of the object S (for example the shoulder width or height of the child which is the object S) (FIG. 2, step 8). The size-identification unit 114 acquires the focal distance information from the imaging unit 102, and the actual size of the object S is set beforehand by the user in the size-identification unit 114.

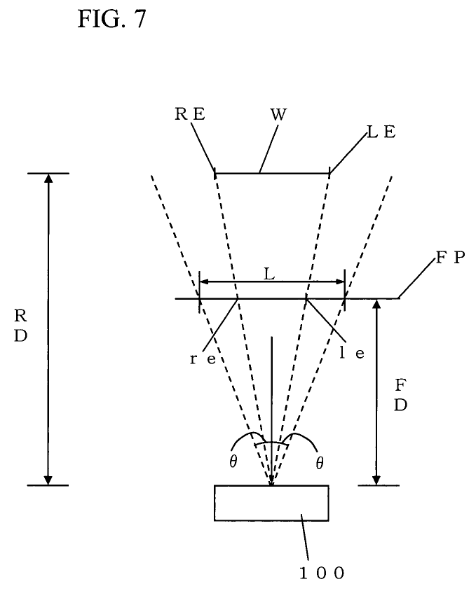

For example, as shown in FIG. 7, the distance between the imaging apparatus 100 and the transmitter 800 that is identified by the distance-identification unit 113 is the distance RD, and the focal distance when the imaging unit 102 took the image of the object S is the focal distance FD, and the actual shoulder width of the child that is the object S is width W. Here, the size-identification unit 114 first identifies the location of the intersection point le where the plane FP, which is a plane parallel to the front surface of the imaging apparatus 100 and which is separated from the front surface of the imaging apparatus 100 by the focal distance FD, crosses a line that connects the left end LE of the width W and the center of the imaging apparatus 100. Similarly, the size-identification unit 114 identifies the location of the intersection point re where the place FP crosses the line connecting the right end RE of the width W and the center of the imaging apparatus 100.

Also, the size-identification unit 114 identifies the length of the line that connects intersection point le and intersection point re, and divides the length of that line by the length L of the imaging range in the horizontal direction of the plane FP, and multiplies the value obtained from that calculation by the length D in the horizontal direction of the image F, to identify the shoulder width W of the child, which is the object S, in the image F.

In this way, the size-identification unit 114 identifies the shoulder width (length in the horizontal direction) of the object S in the image F. Similarly, the size-identification unit 114 identifies the height (length in the vertical direction) of the object S in the image F. Also, the image-identification unit 114 identifies the size of the object S in the image F from the identified shoulder width W and height.

Since the object S in this first embodiment is a child, the size of the object changes within a specified range due to flexing of the arms and legs etc. Therefore, the size-identification unit 114 finally identifies the size of the object S in the image F as the size of the object S identified as described above to which specified lengths are added in both the vertical and horizontal directions (FIG. 2, step 8).

After the location of the transmitter and the size of the object S in the image F are identified, the object-identification unit 115 assumes that the transmitter s located in the center of the object S, and uses the location of the transmitter 800 and size of the object S in the image F to identify the range of the object S (FIG. 2, step 9).

In the case where the transmitter 800 is not attached to the center of the object S, the relationship between the location where the transmitter 800 is attached and the center of the object C is set in the object-identification unit 115. When the positional relationship is set, the object-identification unit 115 takes into consideration this positional relationship and identifies the range of the object S.

For example, when the transmitter is attached to the left side from the center of the body of the child that is the object S, the object-identification unit 115 shifts the range of the object S in the image F to the left side by the distance that the transmitter 800 is shifted to the lift of center when compared with when it is attached to the center.

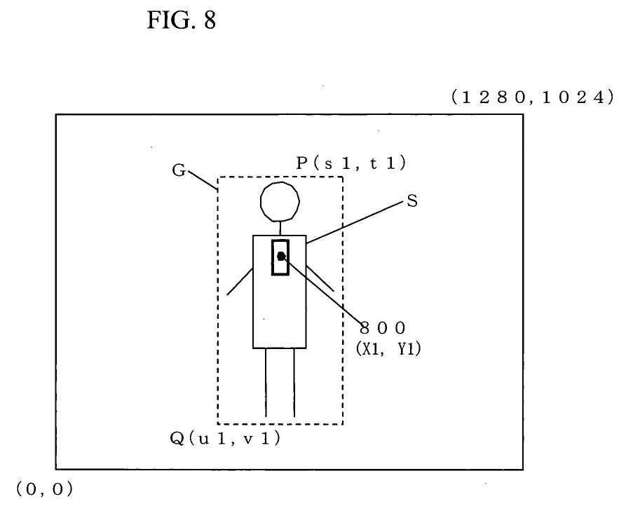

When the rectangular range G indicated by the dashed lines in FIG. 8 is taken to be the range of the object S in the image F, the object-identification unit 115 calculates, for example, the positional coordinates P(s1, t1) of the upper right corner of the rectangle and the positional coordinates Q (u1, v1) of the lower left corner as the positional coordinates that identify that range G in that image.

After the object-identification unit 115 calculates the positional coordinates that identify the range of the object S in the image F in this way, the recording unit 107 records that positional-coordinate information with associated with the image data as size information on the recording medium 900 (FIG. 2, step 10).

When moving images are obtained by the imaging unit 102, the recorded data includes image data, which comprises a plurality of frames that show the movement, and object information, and the object information that is included in the object signal from the transmitter 800 located in a frame image is associated with that frame.

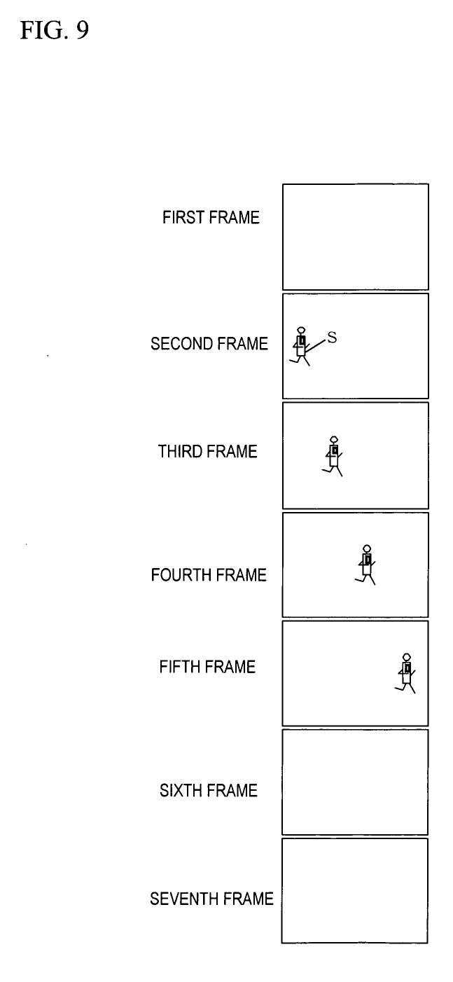

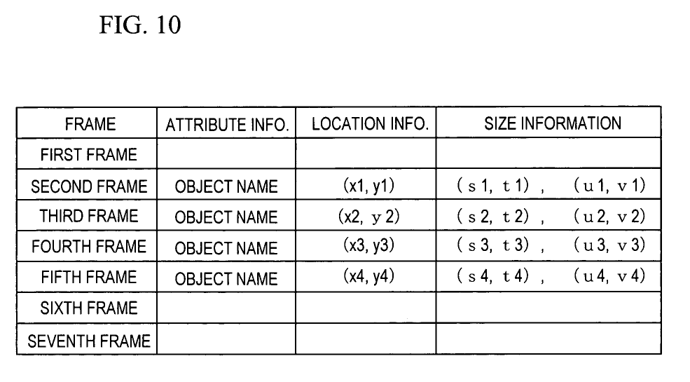

Here, as shown in FIG. 9, the moving image obtained from the imaging unit 102 comprises seven frames. As shown in FIG. 9, of the seven frames, the image is included in the second to the fifth frame, and as shown in FIG. 10, attribute information is associated with the second to fifth frames and recorded on the recording medium 900.

In the first embodiment described above, the transmitter 800 is attached to a child that is the object S, and it transmits an object signal for identifying the name of the object (child) S. However, it is also possible to install an imaging-location-identification unit in the transmitter 800 that identifies the location of the transmitter 800 by GPS, PHS or the like, and for the contents of object information from the transmitter 880 be transmission-location information, which identifies the position of the transmitter 800, and the name of the object.

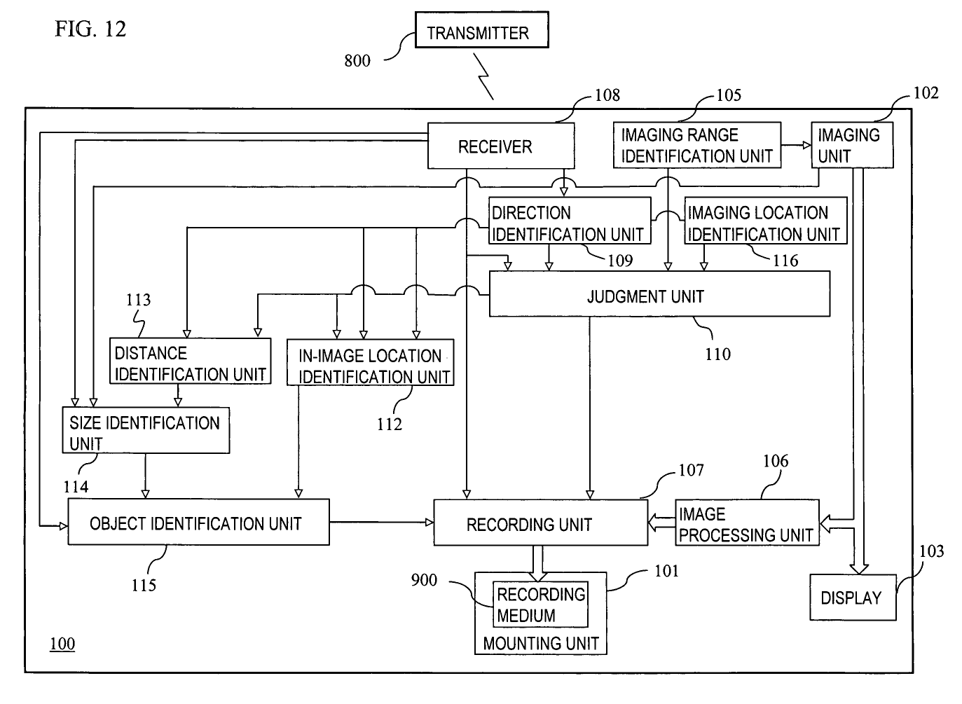

As shown in FIG. 12, when the transmission-location information is taken to be the object information, the imaging apparatus 100 comprises an imaging-location-identification unit 116 that identifies the location of the imaging apparatus 100 by GPS, PHS or the like. At that time, the judgment unit 110 first identifies the imaging range of the imaging unit 102 based on the location of the imaging apparatus 100 identified by the imaging-location-identification unit 116, and the amount of zoom. Also, the judgment unit 110 determines whether or not the transmitter 800 is included in the image F based on that identification result, and the transmission-location information of the object information received by the receiver 108.

When it is possible for the transmitter 800 and imaging apparatus 100 to identify their own current location in this way, the location of the transmitter 800 in the image F is identified as described below.

For example, the direction-identification unit 109 identifies the direction where the transmitter 800 is located with reference to the location of the imaging apparatus 100, based on the location of the imaging apparatus 100 identified by the imaging-location-identification unit 116 and the transmission-location information received by the receiver 108. After that, the imaging-location-identification unit 112 identifies the location of the transmitter 800 (object S) in the image F based on that direction identified by the direction-identification unit 109 and the imaging range when the imaging unit 102 took images of the object S.

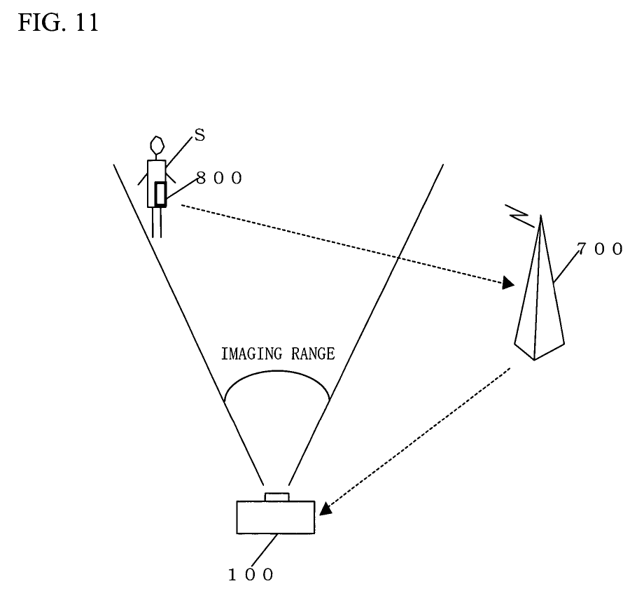

When the transmission-location information is included in the object information, the direction-identification unit 109 does not use the incident angle of the object signal at the receiving sensors 108a, 108b when identifying the direction where the transmitter 800 is located with reference to the location of the imaging apparatus 100. Therefore, as shown in FIG. 11, when the transmission-location information is included in the object signal, the object signal may be transmitted to the imaging apparatus 100 via a relay 700.

Also, in this first embodiment described above, the recording unit 107 records the location information of the transmitter 800 in the image that was identified by the in-image-location-identification unit 112, with the image data with which the location information is associated, on the recording medium 900. The location information of the transmitter 8 is identified based on the imaging range of the imaging unit 102 and the direction of the transmitting source of the object signal that was identified by the direction-identification unit 109. Therefore, instead of the location information for the transmitter 800, the recording unit 107 could record the imaging range of the imaging unit 102 and the direction of the transmitting source of the object signal that was identified by the direction-identification unit 109 on the recording medium 900 as the location information.

Moreover, in the first embodiment described above, the recording unit 107 records the positional-coordinate information identified by the object-identification unit 115 that identifies the range of the object S in the image F as size information, with the image data with which the information is associated on the recording medium 900. However, the range of the object S in the image F is identified according to the location of the transmitter 800 in the image F, the location where the transmitter 800 is attached to the object S and the size of the object S in the image F. Therefore, instead of the positional coordinates, the recording apparatus could record the location of the transmitter 800 in the image F, the location where the transmitter 800 is attached to the object S and the size of the object S in the image F on the recording medium as size information.

Furthermore, as described above, the size of the object in the image F is identified according to the distance between the imaging apparatus 100 and the transmitter 800, the focal distance when the imaging unit 102 took an image of the object S, and the actual size of the object. Therefore, instead of the size of the object S in the image F, the recording unit 107 could record the distance between the imaging apparatus 100 and the transmitter 800 identified by the distance-identification unit 113, the focal distance when the imaging unit 102 took an image of the object S, and the actual size of the object S on the recording medium 900.

Also, as was shown in Equation 4, the distance between the imaging apparatus 100 and the transmitter 800 is identified according to the incident angle of the object signal at the receiving sensors 108a, 108b. Therefore, the recording unit 107 could also record the incident angle of the object signal at the receiving sensors 108a, 108b on the recording medium 900.

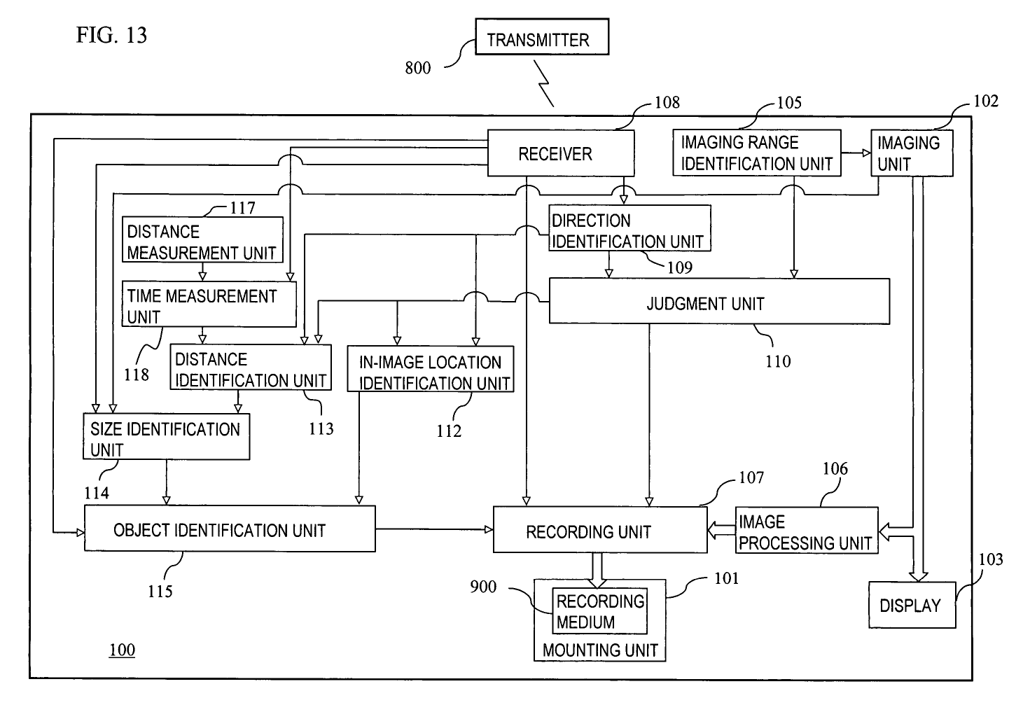

Moreover, the distance between the imaging apparatus 100 and the transmitter 800 can be identified as will be described later. In other words, as shown in FIG. 13, it is presumed that the imaging apparatus 100 comprises a distance-measurement unit 117 and a time-measurement unit 118. The distance-measurement unit 117 is a unit that transmits an infrared ray (or radio waves) in the direction of the transmission source of the object signal identified by the direction-identification unit 109 when the receiver 108 receives the object signal. The time-measurement unit 118 is a unit that measures the time from when the distance-measurement unit 117 transmits an infrared ray until the receiver 108 receives the infrared ray. The infrared ray transmitted by the distance measurement unit 117 is reflected by the object S to which the transmitter 800 is attached, and the receiver 108 receives the infrared ray. The distance identification unit 113 identifies the distance between the imaging apparatus 100 and transmitter 800 by multiplying the ½ the time measured by the time-measurement unit 118 by the speed of the infrared ray.

Therefore, instead of the distance between the imaging apparatus 100 an transmitter 800, the recording unit 107 can record the time information measured by the time-measurement unit 118 and the speed of the infrared ray (or radio wave) on the recording medium 900, with the image data with which the information is associated.

Furthermore, in the first embodiment described above, the transmitter 800 uses infrared rays to constantly transmit an object signal. However, the transmitter does not need to constantly transmit an object signal but can transmit an object signal only when a response-request-signal is received from the imaging apparatus 100.

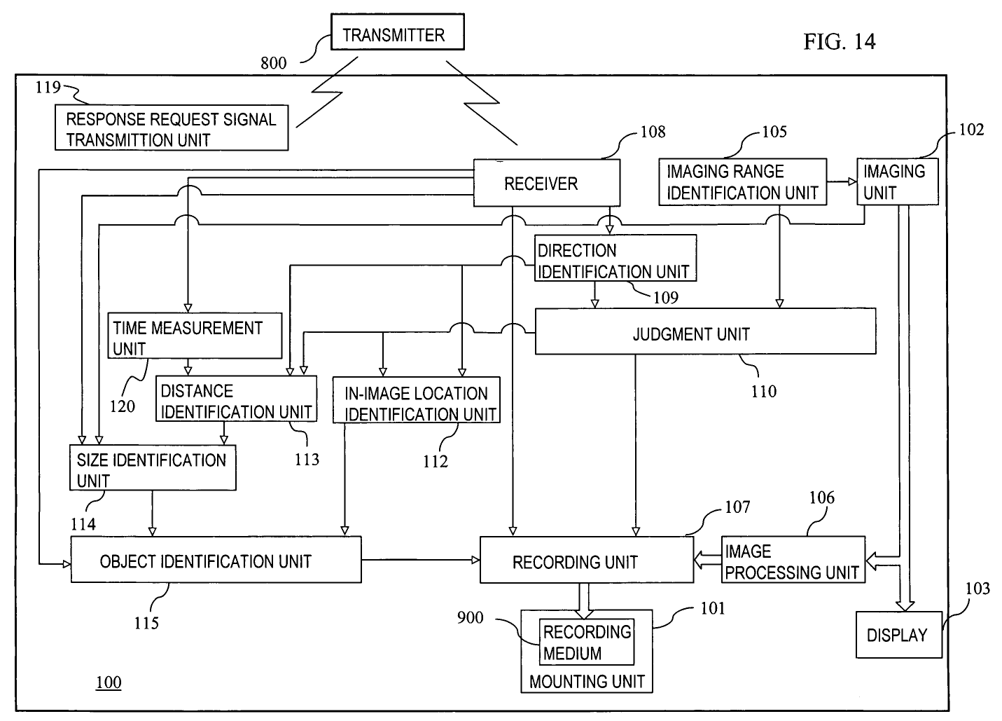

As shown in FIG. 14, in this case, the imaging apparatus 100 comprises a response-request-signal-transmission unit 119 that transmits a response-request signal. It is preferred that this response-request signal be a signal that uses infrared rays, however, it may also be an electrical signal. Also, it is preferred that the response request signal transmission unit 119 constantly transmit a response-request signal, however, instead of constant transmission, it is possible to transmit the response-request signal at specified intervals of times such as every 0.1 second.

Also, in the case where the imaging apparatus comprises a response-request-signal-transmission unit 119, the distance between the imaging apparatus 100 and the transmitter 800 can be identified as follows.

The time-measurement unit 120 measures the time from when the response request signal transmission unit 119 transmits the response-request signal until the receiver 108 receives the object signal from the transmitter 800.

When the transmitter 800 immediately transmits the object signal after receiving the response-request signal, the distance-identification unit 113 identifies the distance between the imaging unit 100 and transmitter 800 by multiplying ½ the time measured by the time-measurement unit 120 by the speed of the response-request signal or object signal.

When the transmitter 800 transmits the object signal after a specified amount of time after receiving the response-request signal, the distance-identification unit 113 identifies the distance between the imaging unit 100 and transmitter 800 by multiplying ½ the time measured by the time-measurement unit 120 from which the specified amount of time has been subtracted, by the speed of the response-request signal or object signal.

Therefore, instead of the distance information of the distance between the imaging apparatus 100 and the transmitter 800, the recording unit 107 can record the time measured by the time-measurement unit 120 and the speed of the response-request signal or object signal on the recording medium 900.

Also, in this first embodiment, the object-identification unit 115 identifies the range of the object S in the image F based on the location of the transmitter 800 in the image F, the location where the transmitter 800 is attached to the object S, and the size of the object S in the image F. However, the object-identification unit 115 can also identify the range of the object S in the image F as described below.

For example, the user stores characteristic information in the object-identification unit 115 in advance about the object S to which the transmitter 800 is attached, such as the color of the clothes the object S is wearing. In that case, the object-identification unit 115 identifies the object S in the image F based on the color that can identify the object S and the location of the transmitter 800 in the image F, by using an image-recognition method such as a contour-detection method that identifies the area of the stored color that includes the transmitter 800, and the boundaries with other areas.

Therefore, instead of the location of the transmitter 800 in the image F, the location where the transmitter 800 is attached to the object S, and the size of the object S in the image F, the recording unit 107 can record the color information that can identify the object S and the location of the transmitter 800 in the image F on the recording medium 900. Also, when the image apparatus 100 comprises an imaging location identification unit 116, and the transmission-location information is the object information, the location of the transmitter 800 in the image F is identified according to the imaging range of the imaging unit 102, the location of the imaging apparatus 100 and the location of the transmitter 800. Therefore, instead of the location information of the transmitter 800, the recording unit 107 can record the imaging range of the imaging unit 102, the location of the imaging apparatus 100 and the location of the transmitter 800 on the recording medium 900 as the location information.

Moreover, when the imaging apparatus 100 comprises an imaging location identification unit 116 and the transmitter 800 transmits a transmission location signal, the distance-identification unit 113 can identify the distance between the imaging apparatus 100 and the transmitter 800 based on the transmission-location information and the location of the imaging apparatus that was identified by the imaging location identification unit 116.

Furthermore, suppose that the user or object attached transmitters 800 at a plurality of locations such as the head or legs of the object S. In that case, the object-identification unit 115 determines the contour of the object S in the image based on the location of each transmitter 800 in the image F, and identifies that contour as the range of the object S in the image F. Therefore, the recording unit 107 can record information that identifies the locations of a plurality of transmitters 800 on the recording medium 900 as size information.

When there is a plurality of transmitters 800, the efficiency at which the imaging apparatus 100 receives the object signal from the transmitters 800 is increased. Also, by averaging the information obtained from the object signals from the plurality of transmitters 800, the imaging apparatus 100 is able to accurately identify the location and the direction of the object S with reference to the location of the imaging apparatus 100, or the location and the size of the object S in the image F, etc.

Furthermore, as described above, instead of the user setting in advance information of the actual size of the object S in the size-identification unit 114, and information about the location where the transmitter 800 is attached to the object S in the object-identification unit 115, the user can set this information in advance in the transmitter 800. In this case, the transmitter 800 is includes this information in the object signal. After receiving the object signal, the receiver 108 extracts the actual size information about the object S and the location information of where the transmitter 800 is attached to the object S from the object signal. Also, the receiver 108 transfers the extracted actual size information about the object S to the size-identification unit 114, and the location information of where the transmitter 800 is attached to the object S to the object-identification unit 115.

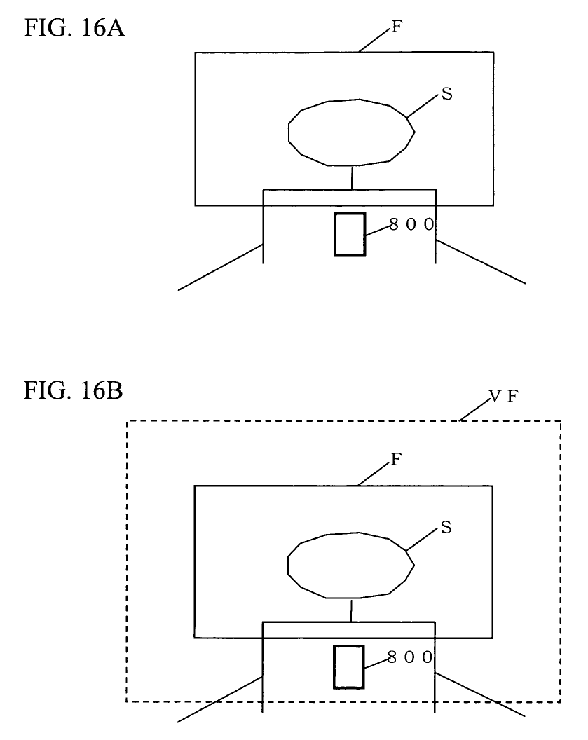

Also, in the first embodiment described above, the judgment unit 110 determines whether or not the transmitter 800 that transmits the object signal is included in the image F. However, as shown in FIG. 16A, there are cases when the transmitter 800 is not included in image F of a close up of the face of the object S. In that case, in this first embodiment, the judgment unit 110 determines that the transmitter 800 is not included in the image F, so the name of the object S is not recorded on the recording medium 900.

Therefore, as shown in FIG. 16B, in addition to the image F actually obtained from the imaging apparatus 102, the judgment unit 110 determines whether or not the transmitter 800 is included in a virtual image VF that includes the area a specified distance on the outside around the outside edge of the image F. When the judgment unit 110 determines that the transmitter 800 is included, the recording unit 107 records the name of the object S to with the transmitter 800 is attached, with the image data with which the name is associated as attribute information on the recording medium 900 .

Moreover, in the first embodiment described above, as explained using FIG. 4 to FIG. 10, the object S was one of the user's children, however the object is not limited to being one person. For example, the object S can be more than one, such as the user's child and a friend. In this case, a transmitter 800 that transmits an object signal for identifying the name of the object S is attached to each of the objects S.

In this case, whether or not the transmitter 800 is included in the image (including the virtual image VF) is determined for the data of each of the images of the moving image obtained from the imaging unit 102 for each transmitter 800. When the transmitter 800 is included in an image, the location information that identifies the location of the transmitter 800 in the image F and the size information that identifies the range G of the object S in that image is associated with the image data and recorded on the recording medium 900 for each transmitter 800.

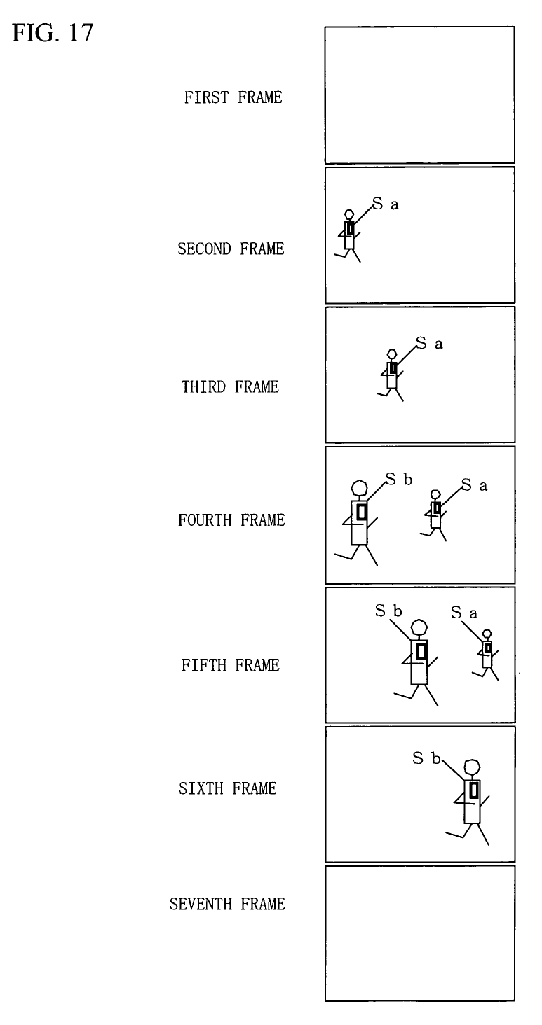

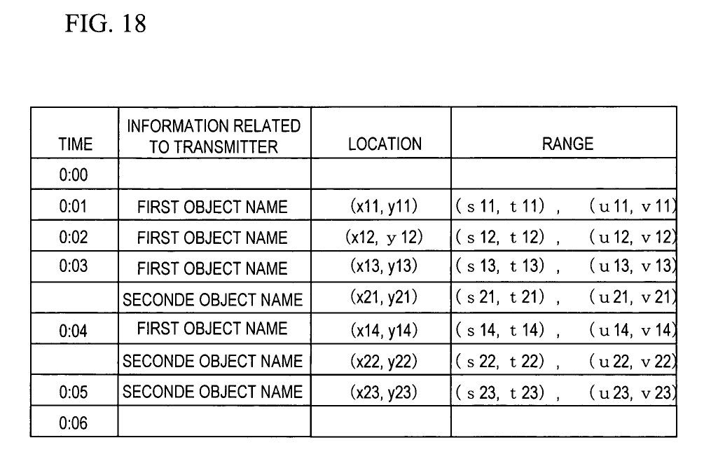

Therefore, as shown in FIG. 17, when the moving image obtained from the imaging unit 102 comprises seven frames that contain a first object Sa and second object Sb, the recording unit 107 records the information shown in FIG. 18 on the recording medium 900, with the image data of each frame with which the information is associated. In other words, the recording unit 107 associates the name of the first object Sa with the image data of the second frame to the fifth frame shown in FIG. 17, and records it on the recording medium to indicate that the first object Sa is included in those four frames, and records that name on the recording medium 900 as attribute information. At the same time, the recording unit 107 records the location information and size information of the first object Sa in the images F of those four frames on the recording medium 900.

Similarly, the recording unit 107 associates the name of the second object Sb with the image data of the fourth frame to the sixth frame shown in FIG. 17, and records it on the recording medium to indicate that the second object Sb is included in those three frames, and records that name on the recording medium 900 as attribute information, records the location information and size information of the second object Sb in those three images on the recording medium 900.

As shown in FIG. 18, the association with the frames, can be performed by setting attribute information at specified times.

Also, in the first embodiment described above, the user points the external lens at the object S and takes images of that object S. However, when the direction of the external lens can be changed independently from the imaging apparatus 100, it is unclear whether or not the external lens is actually pointed toward the object S. When the imaging apparatus has this kind of construction, the actual imaging range when the imaging unit 102 took images of the object S is not certain. Therefore, it is preferred that the imaging apparatus comprise a direction-measurement unit such as a gyro that measures the direction of the external lens, and to make clear the actual imaging range when the imaging unit 102 took images of the object by using the value measured by that direction-measurement unit.

When the imaging apparatus does not comprise a zoom-selection dial or the like and it is not possible to change the image range of the imaging unit 102, the imaging range is constant. Therefore, when the imaging range is constant, by the storing the imaging range in the image-processing apparatus 200 of the second embodiment, the recording unit 107 can delete the imaging range from the location information.

Similarly, when the focal distance and the distance between the imaging apparatus 100 and the transmitter 800 are constant, by storing the focal distance and that distance in the image-processing apparatus 200, the recording unit 107 does not have to record the focal distance and that distance on the recording medium 900.

Furthermore, when the image-processing apparatus 200 stores all or part of the information such as location information of where the transmitter 800 is attached to the object S, actual size of the object S, speed of the response-request signal, speed of the object signal, and color information that is able to identify the object S, the recording unit 107 does not have to record the information that is stored by the image-processing unit on the recording medium 900.

Also, instead of recording image data, attribute information, location information, size information, speed of the response-request signal, speed of the object signal, color information that can identify the object S, or part of the location or size information on the recording medium 900, the recording unit 107 can transfer that information to an information terminal such as the image-processing apparatus, user's personal computer, PDA or the like by way of a network such as the Internet (hereafter, simply referred to as a network). The same configuration of data transferred via the network can be the same as the configuration of the data that was recorded on the recording medium 900. Data necessary for transfer control or error correction can be added to that data as a header or footer.

Also, in the first embodiment described above, the object S was taken to be a child, however, the object S can be something other than a person. For example, the object S can be a work of art such as a painting in a museum, or could be some fixed object such as a building that is a tourist attraction. Also, the object S could be something whose location changes such as an animal or automobile.

When the object S is a fixed object such as a work of art in a museum, or a building that is a tourist attraction, in order to no damage that fixed object S, it is preferred that the transmitter 800 be attached to a specified location a specified distance separated from that fixed object S.

When the transmitter 800 is attached to a specified location separated from the object S, the transmitter 800 transmits the information about the location of the object S as object information.

The judgment unit 110 determines whether or not the object S is included in the image F (including the virtual image VF) based on the information about the location of the object S that is transmitted as object information, and the location of the imaging apparatus that is obtained by the imaging-location-identification unit 116.

Also, by attaching the transmitter 800 to a specified location, it is possible to have the imaging unit 102 take images of an object that comes within a specified distance from the transmitter 800. An object S that comes within the specified distance is detected by an infrared sensor on the transmitter 800. When an object S that comes within the specified distance is detected, the transmitter 800 transmits an object signal having location information of where the transmitter 800 is located as the contents.

The imaging apparatus 100 comprises an external lens that is pointed in the direction where the transmitter 800 is located and when the receiver 108 receives the object signal, the imaging unit 102 takes images around the transmitter 800 at a preset imaging range.

Moreover, in the first embodiment described above, the transmitter 800 that is attached to the object S transmits an object signal for identifying the name of the object S, however, the transmitter 800 can transmit information that can identify the transmitter 800, or information that is related to the object S as object information instead of the name. For example, the transmitter 800 can transmit attribute information of the object S or measurement value information from sensors when sensors are attached to the object S as the object signal. Example of attributes of the object S include age, sex, address, height, telephone number, affiliation, e-mail address when the object is a person. Also, when the object is a work of art such as a painting, or a tourist landmark, attributes could include an explanation, address, Web address, ID code, etc. The sensors could be position measurement devices (GPS, etc.), direction measurement devices (gyro, etc.), acceleration sensor, velocity meter that measures the speed of the object, thermometer, blood-pressure gage, etc. The sensors could be installed or not installed in the transmitter 800. When the sensors are not installed in the transmitter 800, the sensors use radio waves or the like to send the measurement results measured by the sensors to the transmitter 800.

When a plurality of transmitters 800 are attached to the object S, the imaging apparatus 100 can calculate information such as the direction of the object S based on the object signals from the plurality of transmitters 800.

Also, it is possible to give the transmitter 800 the function of writing necessary items such as the name of the object S beforehand from a personal computer of the like, and for the transmitter 800 to transmit an object signal that includes the written items.

For example, in the case where the object S is a work of art in a museum and the transmitter 800 transmits an explanation of the work of art, which is the object S, as the object information, the recording unit 107 records the image data of the image F which includes that work of art together with the explanation of that work of art on the recording medium 900. This has the effect of allowing the user to obtain a video catalog of the work of art by using the imaging apparatus 100 to take an image of a work of art that the user enjoys.

As described above, there can be many possibilities for the contents of the object information, and the recording unit 107 can associate the contents of that object information with the image data and record it on the recording medium as attribute information.

Moreover, as described above, an ID code that identifies the name of the object can be used as the object information. In that case, the imaging apparatus 100 comprises a conversion unit that converts the ID code to a name, and the recording unit 107 records the name converted by that conversion unit on the recording medium 900 as name information that identifies the object S. That conversion unit contains information such as a correspondence table that gives the correspondence between ID codes and names, and it converts the ID code to a name based on that correspondence table. Also, it possible to acquire information such as the aforementioned correspondence table via a network and to convert the ID code to a name using that acquired information. Also, separate from the attribute information, the recording unit 107 can associate the ID code itself with the image data and record it on the recording medium 900 as name information that identifies the name of the object S.

Furthermore, when the object is a work of art in a museum or a building or monument that is a tourist landmark, the ID code for the work of art or monument can be included in the object signal, and the imaging apparatus 100 can acquire detailed information about the work of art or monument based on that ID code via a network. The recording unit 107 can record the acquired detail information on the recording medium 900 as attribute information.

Also, when the recording unit 107 of this first embodiment described above records data other than the image data, such as attribute information or the like, on the recording medium 900, the data other than the image data can be recorded on the recording medium 900 using a method of embedding that data in the image data such as by using electronic watermarking. Besides electronic watermarking, a method of using barcodes, or a method of used a data area that corresponds to edges of the image F (top, bottom, right or left edges) can be used as methods for embedding the information other than image data in the image data.

Also, in the first embodiment described above, the method of storing data when the recording unit 107 associates the image data with the attribute information and records them on the recording medium is not limited. The attribute information can be recorded on the recording medium 900 according to the MPEG7 standard in a state such that it is manageable as metadata for the image data.

Moreover, in the first embodiment described above, moving images were obtained from the imaging unit 102, however it is also possible to obtain still images from the imaging unit 102. In that case, the recording unit 107 records the image data of the still image obtained from the imaging unit 102 on the recording medium 900. Also, in that case, the recording medium could be APS (advanced Photo System) film. When the recording medium is APS film, the recording unit 107 records the image data of the still image obtained from the imaging unit 102 on the recording medium 900 as analog data, and can record the data other than the image data, such as attribute information, on the additional area of that recording medium as digital data.

In this way, according to the characteristics of the recording medium 900, the recording unit 107 records the data to be recorded on the recording medium 900 in the digital state or analog state.

Therefore, the recording medium is not limited and can be a memory card, hard disc, floppy disk or film, and can also be a temporary memory device such as DRAM.

Also, in the first embodiment described above, the recording unit 107 associates attribute information with the image data for each image F and records it on the recording medium 900. However, the recording unit 107 can also record data other than the image data, such as attribute information for data of a set number of images, on the recording medium 900.

Moreover, when the location or size of the object S in the image F changes and exceeds the preset standards, the recording unit 107 can associate data other than the image data, such as attribute information, only with the image data of the image F after that and record it on the recording medium 900.

Furthermore, the imaging apparatus 100 of the first embodiment described above can be a portable telephone that has all of the functions of the imaging apparatus 100. Similarly, the transmitter 800 of the first embodiment described above can be a portable telephone that has all of the functions of the transmitter 800.

### Second Embodiment

Next, the construction and operation of the image-processing apparatus 200 of a second embodiment of the invention will be explained.

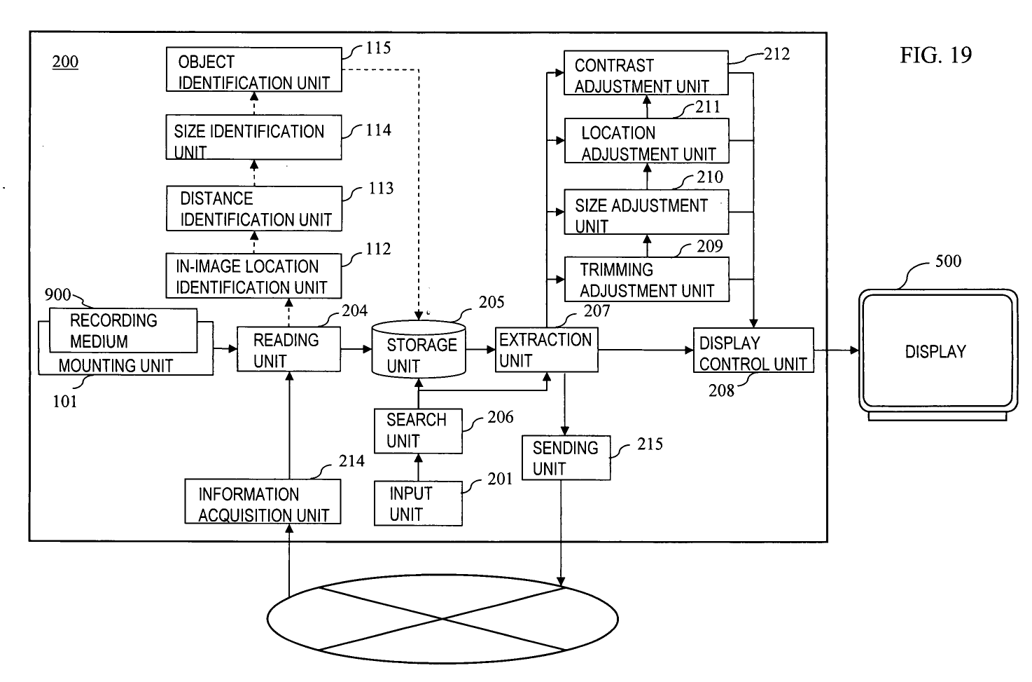

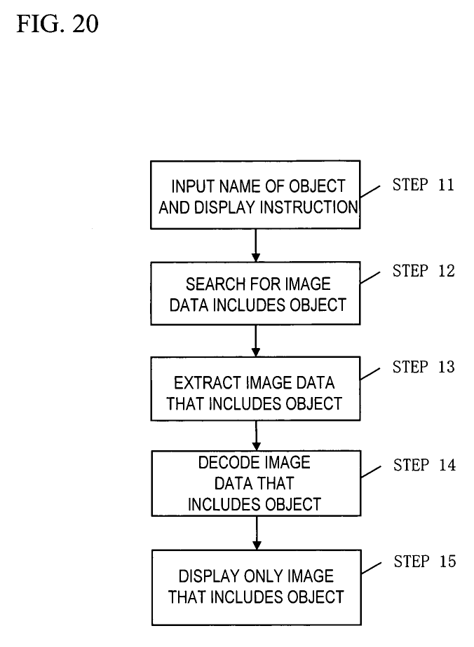

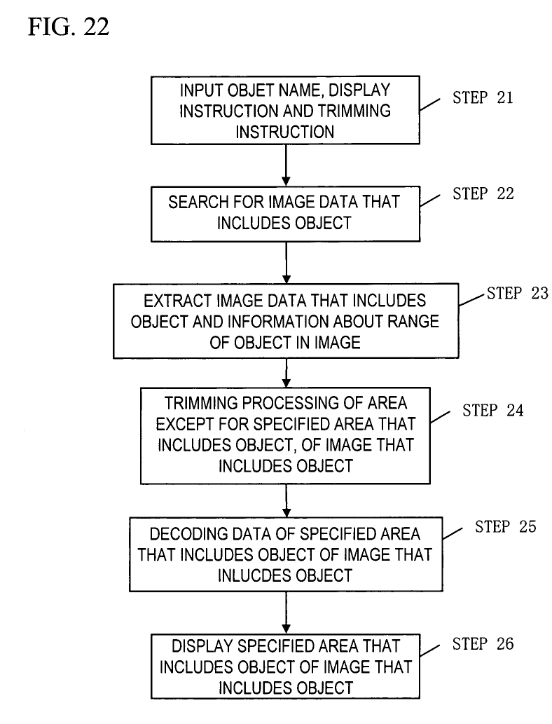

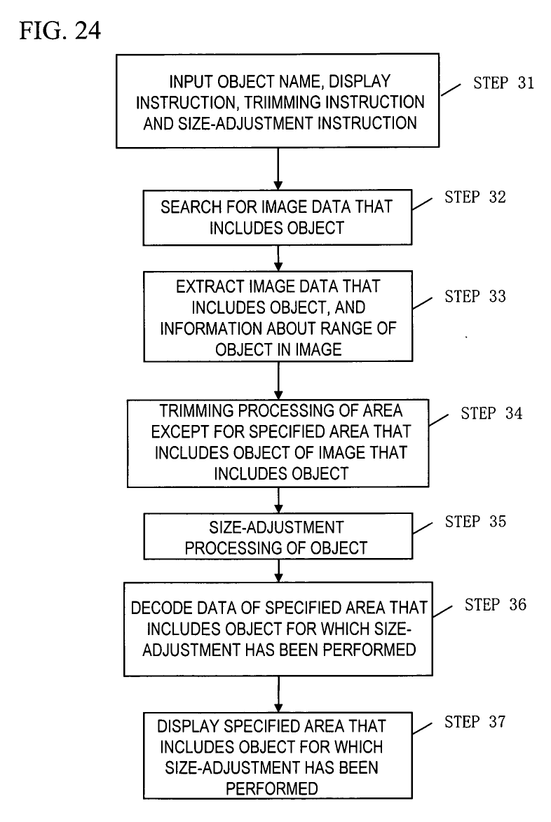

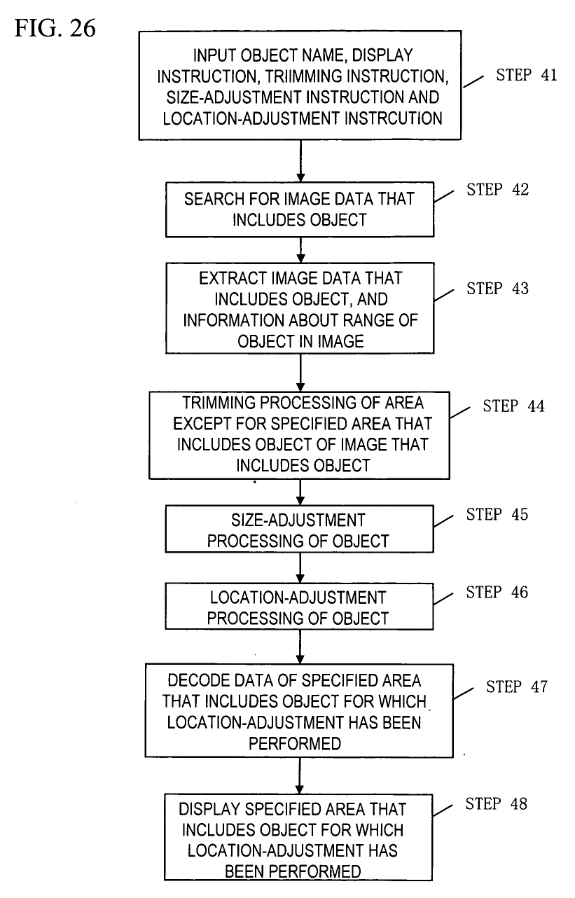

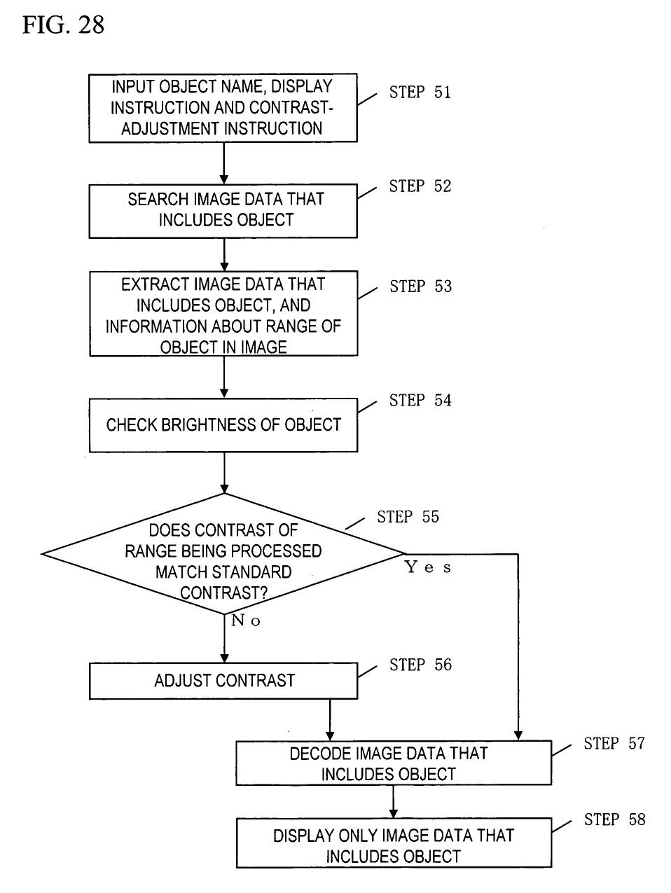

FIG. 19 s a block diagram of the image-processing apparatus 200 of this second embodiment, and FIG. 20, FIG. 22, FIG. 24, FIG. 26 and FIG. 28 each show the operating procedure of the image-processing apparatus 200.

In this second embodiment, it is presumed that the image-processing apparatus 200 executes a desired process for the image data that was recorded on the recording medium by the imaging apparatus 100 of the first embodiment described above, based on the attribute information (metadata) associated with that image data and recorded on the recording medium 900.

Here, the image data stored on the recording medium 900 is image data of moving images comprising the seven frames shown in FIG. 9. Also, the attribute information that is stored on the recording medium is the name of the object S. Moreover, as shown in FIG. 10, on the recording medium, the object S is included in the second to the fifth frames of the seven frames shown in FIG. 9. Furthermore, on the recording medium 900, as shown in FIG. 10, location information for the transmitter in the four frames, and the size information that identifies the range of the object S in those four frames are recorded.

Under the presumed conditions described above, in order to use the image-processing apparatus 200 to execute a desired process on the image data of the seven frames stored on the recording medium 900, the user moves the image data and attribute information to a storage unit 205. This storage unit 205 is a memory that can be accessed directly by each unit of the image-processing apparatus 200.

More specifically, the user removes the recording medium 900 from the mounting unit 101 of the imaging unit 100 and mounts it in the mounting unit 201 of the image-processing apparatus 200. Next, the user enters an instruction to store the data stored on the recording medium 900 on the storage unit 205 using the input unit 202. After the instruction has been input, a reading unit 204 reads the image data stored on the recording medium 900 according to the instruction, and stores it in the storage unit 205.

(1) Here, it is supposed that the user displays just the images F that include the object S, which is the user's child, on the display apparatus 500 connected to the image-processing apparatus 200. In that case, the user uses the input unit 202 to input the name of the object S (one example of attribute information) and a display instruction (FIG. 20, step 11). This starts the search unit 206.

The search unit 206 searches for image data with which the name of the object S input by the user is associated as attribute information from the storage unit 205 (FIG. 20, step 12). The search unit 206 detects the four items of image data for second to the fifth frames, and an extraction unit 207 extracts the four items of image data, the name of the object S as the attribute information associated with the four items of image data, and the location information from the storage unit 205 (FIG. 20, step 13).

The four items of image data extracted by the extraction unit 207 are image data for which a compression process has been performed as described above. Therefore, the display-control unit 208 decodes the video signal such that the four items of image data that were extracted can be displayed on the display apparatus 500 (FIG. 20, step 14). Together with that, the display-control unit 208 decodes the name-display signal such that the name can be displayed on display apparatus 500. Also, when the images F that were extracted by the extraction unit 207 are displayed on the display apparatus 500, the display-control unit 208 multiplexes the name-display signal with the video signal such that the name of the object S is displayed underneath the object.

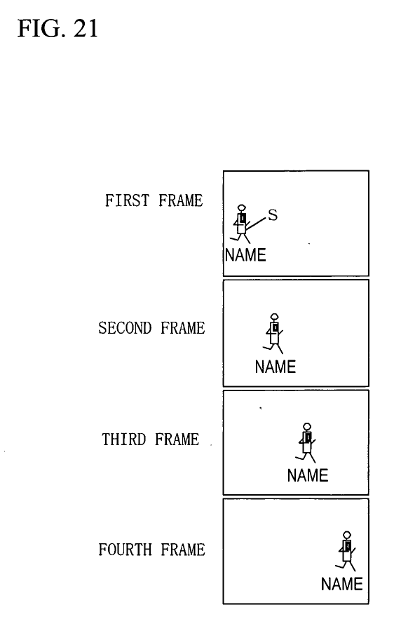

Also, the display-control unit 208 sends the video signal embedded with the name data of the object S to the display apparatus 500. As shown in FIG. 21, together with displaying the moving images for just the four items of image data based on the received video signal (FIG. 20, step 15), the display apparatus 500 displays the name of the object S in each image underneath the object S.

Since just the images F that include the object S are displayed on the display apparatus 500 together with the name of the object S underneath the object S in this way, the user is able to view the object very efficiently.

For example, in the case where image data that includes the object S and that was taken on a different day is stored in the storage unit 205, when the user uses the input unit 202 to input the name of the object S and a display instruction, the image data for all of the images F that include the object S is displayed by the display apparatus 500 regardless of the date when the image was taken. Therefore, it is possible to display a video digest of object S on the display apparatus 500.

In (1) described above, just the images F that include the user's child as the object S are displayed by the display apparatus 500, so the user can view the images F that include the object S, however it is not possible to view the images F before or after the displayed images. Therefore, it may not always be possible for the user to get a complete understanding of the contents of the images F displayed by the display apparatus 500 that include the object S. For example, supposing that the all the image data of moving images of a basketball event at the sports festival in which the user's child participated is stored in the storage unit 205. In that case, since only the images F that include the object S are displayed, the user is not able to get a complete understanding of the basketball event.

Therefore, so that the user can easily gain an understanding of the overall basketball event, the extraction unit 207 not only extracts the images data of the images F that include the object S, but also extracts the image data from the storage unit 205 of a specified number of images F before and after the images F that include the object S in order to display not only the images F that include the object S, but also a specified number of images before and after those images (for example, images for one minute before and after the images F.

By also extracting image data for a specified number of images F before and after the images F and displaying them on the display apparatus 500, the user is able to gain a good understanding of the contents of the images that include the object S.

Moreover, in (1) described above, when the images F that include the object S are displayed by the display apparatus 500, the name of the object S is also displayed, however, it is also possible not to display the name of the object S. In that case, the extraction unit 207 does not extract the name of the object S from the storage unit 205.

(2) Incidentally, not just the object S but other people or objects are also included in the image data of the sports festival of which images were taken by the imaging apparatus 100. Therefore, as was explained in (1), even when images that include the object S are displayed on the screen of the display apparatus 500, the object S may be displayed with a small size that is only about 10% of the size of the screen of the display apparatus 500. In this case, it is difficult for the user to see the object S in the displayed image F and to identify the object S.

Therefore, when the user desires to display just the object S and the area in a specified distance range from the object S on the display apparatus 500, in addition to the name of the object S and display instruction, the user inputs a trimming instruction from the input unit 202 (FIG. 22, step 21). This starts the search unit 206.

As explained above, the search unit 206 finds the image data for the images of the second to the fifth frame of the seven frames shown in FIG. 9 (FIG. 22, step 22), and the extraction unit 207 extracts the image data for those images F, and the range information for the object S in the four images from the storage unit 205 (FIG. 22, step 23).

The trimming-adjustment unit 209 performs a trimming process (removal) (hereafter, this process will be called the trimming process) of the object S and area at the specified distance from the object S for each of the four images based on the size information for the image F that was extracted by the extraction unit 207 (FIG. 22, step 24).

The display-control unit 208 decodes the image data for the images F for which the trimming process was performed into a video signal (FIG. 22, step 25), and sends that video signal to the display apparatus 500.

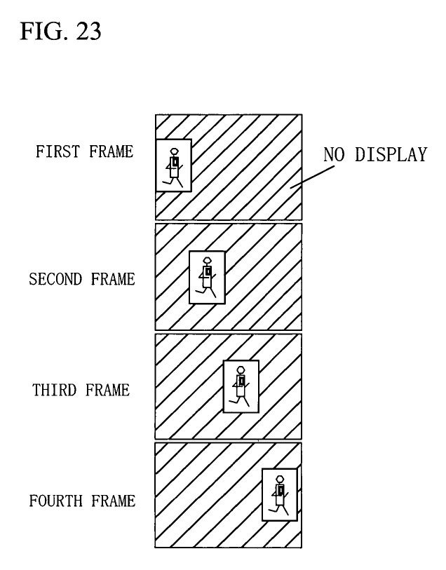

As shown in FIG. 23, the display apparatus 500 displays just the object S and the area in a specified distance range from the object S for the images F shown in FIG. 21 based on the received video signal (FIG. 22, step 26).

By performing this trimming process and displaying the object S and the area within a specified distance range from the object S on the display apparatus 500, the user is able to easily see and identify the object S displayed on the display apparatus 500.

In (2) described above, the name of the object S is not displayed, however, as was described in (1), it is also possible to display the name of the object S.

(3) Even though of the images F that include the object S, only the object S and the area within a specified distance range from the object S are displayed as described above in (2), there are cases when the object S in the images F may still be displayed at a small size of about 10% of the size of the screen of the display apparatus 500.

Therefore, when the user desires to display the object S larger, in addition to the name of the object S, the display instruction and trimming instruction, the user inputs a size-adjustment instruction using the input unit 202 for displaying the object S at a size of about 40% the size of the screen of the display apparatus 500 for example (FIG. 24, step 31).

By doing this, the search unit 206, extraction unit 207 and trimming-adjustment unit 209 perform the operation as explained in (2) (FIG. 24, steps 32 to 34).

The size-adjustment unit 210 adjusts the size (hereafter, this process will be referred to as the size-adjustment process) of the four images such that the size of the object S, which is included in the image data of the four images (four images shown in FIG. 23) that were trimmed by the trimming-adjustment unit 209, is about 40% of the size of the screen of the display apparatus 500 (FIG. 24, step 35).

The display-control unit 208 decodes the image data for the four images for which the size was adjusted by the size-adjustment unit 210 into a video signal (FIG. 24, step 36), and sends that video signal to the display apparatus 500.

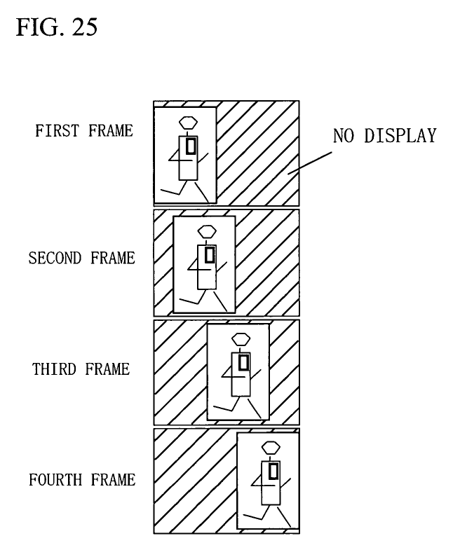

As shown in FIG. 25, the display apparatus 500 displays the object S and the area within a specified distance range from the object S of the images F shown in FIG. 23, and displays the object S at a size that is 40% the size of the screen of the display apparatus 500 (FIG. 24, step 37).

By performing the size-adjustment process in this way, it is possible to increase the size of the displayed object S, so even when the size of the object S included in the trimmed image data is small the user can clearly identify the object displayed on the display apparatus 500.

In (3) described above, the name of the object is not displayed, but as described in (1), it is also possible to display the name of the object S.

In (3), the size-adjustment unit 210 performed the size-adjustment process on the images for which the trimming-adjustment unit 209 performed the trimming process. However, the size-adjustment unit 210 can also perform the size-adjustment process on image data that has not been trimmed.

In that case, when the images for which the size-adjustment unit 210 performed are displayed by the display apparatus 500, there is a good possibility that the image will not fit on the screen of the display apparatus 500. However, since the image is usually taken such that the object S is in the center of the image F, by having the display apparatus 500 display the center of the image, there better possibility that that the image F will be displayed on the display apparatus 500 as shown in FIG. 25. When the size-adjustment process is performed on the image data without performing the trimming process, the user only needs to input the name of the object S, the display instruction and the size-adjustment instruction using the input unit 202.

(4) In (3), performing the size-adjustment process on the image data such that the object S is displayed large with respect to the size of the screen of the display apparatus 500 was explained. However, as shown in FIG. 25, the position where the object S is displayed on the screen is not constant. In other words, there may be cases in which the object S is displayed on the right side of the screen of the display apparatus 500, and there are cases in which it is displayed on the left side. Therefore there are times when the user will have to change the direction of sight when viewing the object displayed by the display apparatus 500.

Therefore, supposing that in order for the user to avoid having to change the direction of sight when viewing the object S, it may be desired that the object S be displayed at a fixed place, for example the center, of the screen of the display apparatus 500. In this case, in addition to the name of the object, display instruction, trimming instruction and size-adjustment instruction, the user uses the input unit 202 to input a location-adjustment instruction for displaying the object S at a fixed place, for example the center, of the screen of the display apparatus 500 (FIG. 26, step 41).

By doing this, the search unit 206, extraction unit 207, trimming-adjustment unit 209 and size-adjustment unit 210 perform the respective operations described in (2) or (3) (FIG. 26, step 42 to step 45). The image data of the images for which the size-adjustment process was performed by the size-adjustment unit 210 is transferred to the location-adjustment unit 211 from the size-adjustment unit 210. The location-adjustment unit 211 uses location information to adjust the location (hereafter, this process will be referred to a the ‘location-adjustment process’) in the image F of the object S that is included in the image data so that the object S included in the image data extracted by the extraction unit 207 is displayed at a fixed position, such as the center, in the image F (FIG. 26, step 46).

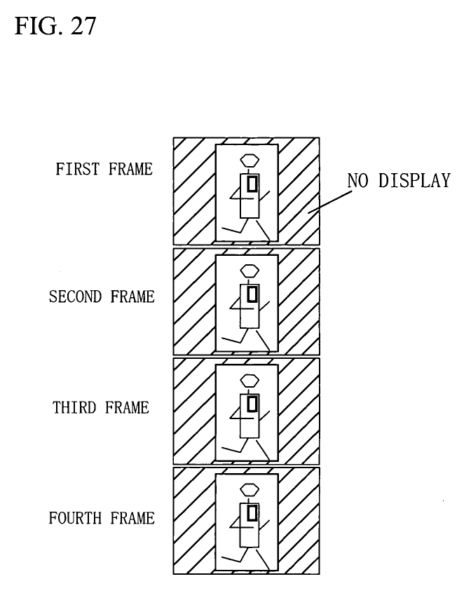

The display-control unit 208 decodes the image data of the images F for which the location-adjustment process was performed by the location-adjustment unit 211 into a video signal (FIG. 26, step 47), and sends that video signal to the display apparatus 500. As shown in FIG. 27, the display apparatus 500 displays the object S at a fixed place, such as the center of the screen of the display apparatus 500 for each image F shown in FIG. 25, based on the received video signal (FIG. 26 step 48).

Since the object S is displayed at a fixed place, such as the center of the screen of the display apparatus 500 in this way, the user is able to identify the object S in the images F displayed by the display apparatus 500 without having to change direction of sight.

In (4) described above, the name of the object was not displayed, however similar to as was described in (1), the name of the object S can also be displayed.

Also, in (4) described above, the location-adjustment unit 211 performed the location-adjustment process on the image data for which the size-adjustment process was performed by the size-adjustment unit 210. However, the location-adjustment unit 211 can also perform the location-adjustment process on image data for which the size-adjustment process has not been performed. In this case, since the size-adjustment process has not been performed by the size-adjustment unit 210, the object S in the images F will be displayed at a fixed place, for example the center of the screen of the display apparatus 500 at the size of the object S in the image F of the image data extracted by the extraction unit 207. Cases in which the location-adjustment process would be performed without performing the size-adjustment process, could include the case when a close up image of the object S is taken. This has the merit of saving energy since the size-adjustment 210 is not activated.

Also, since the extraction unit 207 extracts the information about the range of the object S in the images F from the storage unit 205 the location-adjustment unit 211 can perform the location-adjustment process on the untrimmed image data of the four images extracted by the extraction unit 207 based on the size information extracted by the extraction unit 207. Also, the location-adjustment unit 211 can perform the location adjustment process on the image data of the four images for which the trimming process was performed.

(5) Incidentally, as was explained in (2), the image data stored in the storage unit 205 is image data taken at a sports festival. Therefore, it is possible that the images of the object S may be taken with backlighting or under dark conditions. In the case of images taken under these kinds of conditions, the contrast of the object S in the image data is less than the normal contrast. When the contrast of the object S in the image F is less than the normal contrast, it is becomes difficult for the user to clearly identify the object S in the images F displayed by the display apparatus 500.

Therefore, when the user desires to clearly display the object S, in addition to the name of the object S and the display instruction, the user can use the input unit 202 to input a contrast-adjustment instruction (FIG. 28, step 51).

By doing this, as was explained in (1), the search unit 206 finds the image data for the second to fifth frames shown in FIG. 9 (FIG. 28, step 52), and the extraction unit 207 extracts the four images of data and the name of the object S from the storage unit 205 (FIG. 28, step 53). Moreover, the extraction unit 207 extracts the size-range information for each of the four images from the storage nit 205 (FIG. 28, step 53).

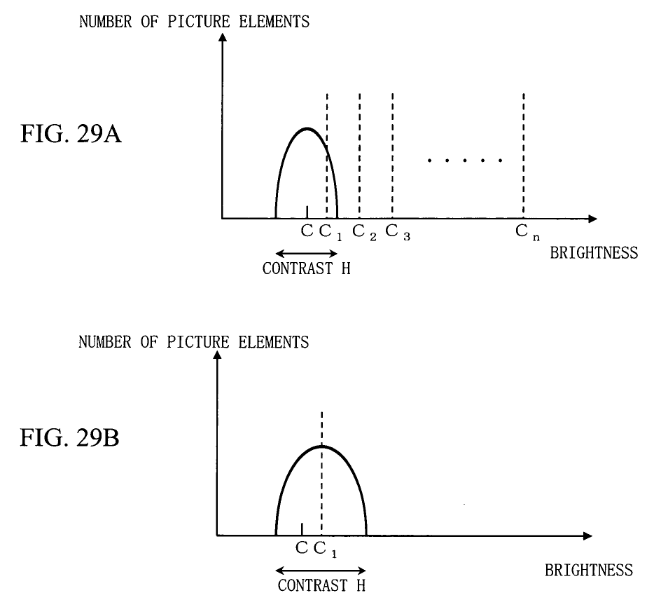

The contrast-adjustment unit 212 checks the brightness of each of the picture elements of the object S in that image data for those four images based on the size information for the object S in those four images that was extracted by the extraction unit 207 (FIG. 28, step 54). The distribution showing the number of picture elements for each brightness level that was checked by the contrast-adjustment unit 212 is expressed as shown in FIG. 29A for example.

Next, the contrast-adjustment unit 212 compares the difference h between the minimum and maximum values of the brightness levels it checked (contrast h of the range (object S) to be processed) (see FIG. 29A) and the preset standard contrast H at which the user can clearly see the object S (difference H between the minimum and maximum brightness values that were preset for the range to be processed) (FIG. 28, step 55). When the contrast h of the range being processed matches the standard contrast H the contrast-adjustment unit 212 does not perform contrast adjustment.

When the contrast h of the range (object S) being processed does not match the standard contrast H, the contrast-adjustment unit 212 adjusts all of the brightness values of the object S as will be described below such that the contrast h of the range (object S) being processed matches the standard contrast H. Of course, when contrast adjustment is performed when the contrast h of the range (object S) being processed is less than the standard contrast H, the difference between the minimum and maximum brightness values of the object S after contrast adjustment is larger than difference between the minimum and maximum brightness values of the object S before contrast adjustment. Therefore, when the minimum brightness value of the object S before contrast adjustment is a little larger than the minimum brightness value that can be expressed by the display apparatus 500, then when contrast adjustment is performed such that the value between the minimum and maximum brightness values of the object before and after contrast adjustment is performed does not change, there is a possibility that the minimum brightness value of the object S after contrast adjustment will not be able to be expressed.

In order to avoid this kind of problem, the contrast-adjustment unit 212 stores in advance some standard values Cn (n=1, 2, 3, . . . ) as values between the minimum and maximum brightness values of the object S after contrast adjustment such that it is possible to express all of the brightness values of the object S after contrast adjustment. Also, the contrast-adjustment unit 212 selects the standard value Cn that is the closest to the value c between the minimum and maximum brightness values that it checked such that there is very little if any change in the brightness of the object S before and after contrast adjustment. Here, in order to simplify the explanation, the standard value Cn that is nearest the middle value c is taken to be C1, and the contrast-adjustment unit 212 selects C1 as the standard value Cn nearest the middle value c.

After the value C1 has been selected in this way, the contrast adjustment unit 212 multiplies the differences between the brightness values Cx of the each of the picture elements of the object S in the image F and the middle value c (Cx−c) by the contrast-adjustment coefficient H/h, which is the standard contrast H divided by the contrast of the range being processed (object S). Also, the contrast-adjustment unit 212 sets the brightness value of each of the images F after contrast adjustment to the value of (Cx−c)H/h subtracted from the value C1 (C1−(Cx−c)H/h) (FIG. 28, step 56). When contrast adjustment is performed in this way, the distribution shown in FIG. 29A is changed to as shown in FIG. 29B.

As described above, the contrast of the object S (processed range) after contrast becomes the standard contrast H. Therefore, when the image data after contrast adjustment is displayed on the display apparatus 500, the user is able to clearly identify the object S in the displayed images F.

Incidentally, there are areas in the image F other than the object. Therefore, when contrast adjustment is performed for just the object S, there is a possibility that when displaying that image F on the display apparatus 500, the user will see the object S and the area other than the object S as being disassociated even though they are in the same image.

Therefore, in order that the user does not see the object S and the area other than the object S as being disassociated, the contrast adjustment unit 212 performs contrast adjustment for the area other than the object S as well. This contrast adjustment is performed using the same method that was used to perform the contrast adjustment of the object S.

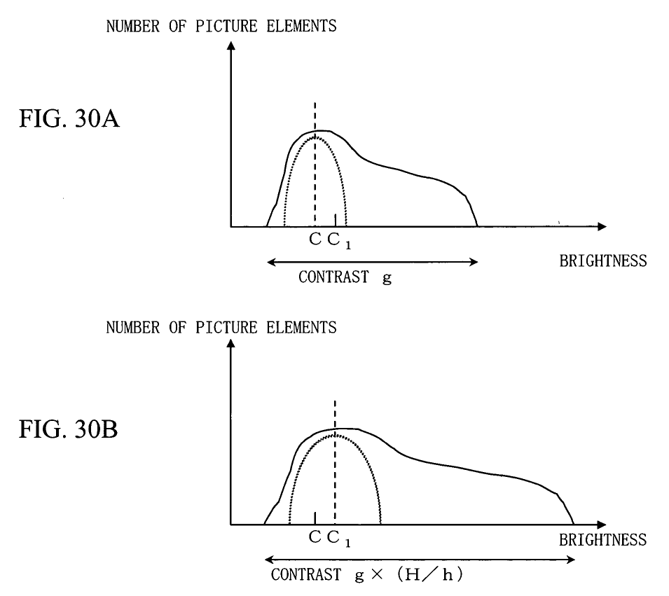

After contrast adjustment has been performed for the area other than the object S in this way, the distribution showing the number of brightness levels of each picture element of an entire image before contrast adjustment as shown in FIG. 30A is changed to the distribution as shown in FIG. 30B. In other words, when the difference (contrast) between the minimum and maximum brightness levels of the entire imaged before contrast adjustment is taken to be g (see FIG. 30A), the difference (contrast) between the minimum and maximum brightness value of the entire image after contrast adjustment is g(H/h) (see FIG. 30B). The dashed line in FIG. 30A shows the distribution in FIG. 29A, and the dashed line in FIG. 30B shows the distribution in FIG. 29B.

By doing this, the images F displayed on the display apparatus 500 are easy to see, and there is very little possibility that the object S and areas other than the object S will appear to be disassociated.

After the contrast-adjustment unit 212 finishes contrast adjustment of the image data for the images F as described above, the display-control unit 208 decodes the image data of the image F for which the contrast was adjusted by the contrast-adjustment unit 212 into a video signal (FIG. 28, step 57), and decodes the name of the object S extracted by the extraction unit 207 into a name-display signal. When the contrast h of the range being processed (object S) matches the standard contrast H (FIG. 28, step 55), the display-control unit 208 decodes the image data of the image F for which the contrast was not adjusted by the contrast-adjustment unit into a video signal (FIG. 28, step 57).

The video signal and the name-display signal are sent to the display apparatus 500, and the display apparatus 500 display in order the images F based on the received video signal (FIG. 28, step 58), and as explained in (1), displays the name of the object S underneath the object S. Also, in the case of (5), the contrast-adjustment unit 212 performs contrast adjustment for the images F based on the image data for the images F extracted by the extraction unit 207, however, the contrast-adjustment unit 212 can also perform contrast adjustment for the images F for which, the trimming process, size-adjustment process or location-adjustment process has been performed.

Incidentally, instead of recording the location information of the transmitter 800 on the recording medium 900 as explained above, the imaging range of the imaging unit 102 and the direction of the transmission source of the object signal identified by the direction-identification unit 109, or the imaging range of the imaging unit 102, the location of the imaging apparatus 100 and the location of the transmitter 800 may be recorded as location information. However, in order to execute image processing such as the trimming process, size-adjustment process, location-adjustment process, and contrast-adjustment process described above, the location information of the transmitter 800 is necessary. Therefore, when it is presumed that the imaging range of the imaging unit 102 and the direction of the transmission source of the object signal identified by the direction-identification unit 109, or the imaging range of the imaging unit 102, the location of the imaging apparatus 100 and the location of the transmitter 800 are recorded on the recording medium 900, the image-processing apparatus comprises an in-image-location-identification unit 112.

Also, instead of recording information about the location coordinates that identify the range of the object S in the image F on the recording medium 900 as size information as was explained in the first embodiment, the location of the transmitter 800 in the image F, the location where the transmitter 800 is attached to the object S, and the size of the object S in the image F may be recorded. However, in order to execute image processing as described above, information about the location coordinates that identify the range of the object S in the image F is necessary. Therefore, when it is presumed that the location of the transmitter 800 in the image F, the location where the transmitter 800 is attached to the object S, and the size of the object S in the image F are recorded on the recording medium 900 as size information, the image-processing apparatus 200 comprises an object-identification unit 115.

Also, a plurality of transmitters 800 may be attached to the object S as was explained in the first embodiment. In this case, the locations of each of the transmitters 800 in the image F are recorded on the recording medium, so the object-range-identification unit 115 of the image processing apparatus 200 can determine the contour of the object S in the image F based on the locations of each of the transmitters 800 in the image F, and identify that contour as the range of the object in the image F.

Moreover, instead of recording the size of the object S in the image F on the recording medium 900 as was explained in the first embodiment, the distance between the imaging apparatus 100 and the transmitter 800, the focal distance when the imaging unit 102 took images of the object S, and the actual size of the object S may be recorded. However, in order to execute the image processing described above, the size of the object S in the image F is necessary. Therefore, when it is presumed that the distance between the imaging apparatus 100 and the transmitter 800, the focal distance when the imaging unit 102 took images of the object S, and the actual size of the object S are recorded on the recording medium 900, the image-processing apparatus 200 comprises a size-identification unit 114.

Also, instead of recording the size of the object S in the image F on the recording medium 900 as was explained in the first embodiment, information about the distance between the imaging apparatus 100 and the transmitter 800 that is identified by the distance-identification unit 113, the focal distance when the imaging unit 102 took images of the object S, and the actual size of the object S may be recorded. However, in order to execute the image processing described above, the size of the object S in the image F is necessary. Therefore, when it is presumed that information about the distance between the imaging apparatus 100 and the transmitter 800 that is identified by the distance-identification unit 113, the focal distance when the imaging unit 102 took images of the object S, and the actual size of the object S are recorded, the image-processing apparatus 200 comprises a size-identification unit 114.

Moreover, instead of recording the distance between the imaging apparatus 100 and the transmitter 800 on the recording medium 900 as was explained in the first embodiment, the incident angle of the object signal at the receiving sensors 108a, 108b may be recorded. Also, instead of recording the distance between the imaging apparatus 100 and the transmitter 800, the time measured by the time-measurement unit 118 and the speed of the infrared rays (or radio waves), or the time measured by the time-measurement unit 120 and the speed of the response-request signal or object signal may be recorded. However, in order to execute the image processing described above, the size of the object S in the image F is necessary. Therefore, when it is presumed that the time measured by the time-measurement unit 118 and the speed of the infrared rays (or radio waves), or the time measured by the time-measurement unit 120 and the speed of the response-request signal or object signal are recorded on the recording medium 900, the image-processing apparatus 200 comprises the distance-identification unit 113 that was installed in the imaging unit 100.

Furthermore, instead of recording the distance between the imaging apparatus 100 and the transmitter 800 on the recording medium 900, the location of the imaging apparatus 100 and the location of the transmitter 800 may be recorded. When this kind of case is presumed, the image processing apparatus comprises the distance-identification unit 113.

When the image-processing apparatus 200 comprises the in-image location identification unit 112, distance-identification unit 113, size-identification unit 114 and object-identification unit 115 in this way, the reading unit 204 inputs the image data, attribute information associated with that image data, location information and size information that are read from the recording medium 900 into the in-image location identification unit 112.

The in-image-identification unit 112 determines whether or not there is information giving the location of the transmitter 800 in the image F in the input data. When it is determined that there is such information, that input data is transferred to the distance-identification unit 113. On the other hand, when it is determined that there is no such information, the in-image-identification unit 112 identifies the location of the transmitter 800 in the image F as in the first embodiment. Also, it adds the information that identifies the location of the transmitter 800 in the image F to the input data and transfers it to the distance identification unit 113.

After the data has been input from the in-image location identification unit 112, the distance-identification unit 113 determines whether or not there is information giving the distance between the imaging apparatus 100 and the transmitter 800 in the input data. When it is determined that there is such information, the distance-identification unit 113 transfers the input data to the size-identification unit 114. On the other hand, when it is determined that there is no such information, the distance identification unit 113 identifies the distance between the imaging apparatus 100 and the transmitter 800 as in the first embodiment. It then adds the information about the distance between the imaging apparatus 100 and the transmitter 800 to the input data and transfers it to the size identification unit 114.

After the data has been input from the distance-identification unit 113, the size-identification unit 114 determines whether or not there is information about the size of the object S in the image F in the input data. When it is determined that there is such information, the size-identification unit 114 transfers the input data to the object identification unit 115. However, when it is determined that there is no such information, the size-identification unit 114 identifies the size of the object S in the image F as in the first embodiment. It then adds the information about the size of the object S in the image F to the input data and transfers it to the object-identification unit 115.

After the data is input from the size-identification unit 114, the object-identification unit 115 determines whether or not there is size information in the input data. When it is determined that there is such information, the object-identification unit 115 transfers the input data to the reading unit 204. However, when it is determined that there is no such information, the object-identification unit 115 identifies the size information as in the first embodiment. It then adds the size information to the input data and stores it in the storage unit 205.

Besides using a recording medium 900, image data can be moved from the imaging apparatus 100 to the image-processing apparatus 200 by way of a network such as the Internet. When moving image data via a network, the image data is input by the reading unit by way of the information acquisition unit 214 of the image-processing apparatus 200.

When displaying an image F that includes the object S on the display apparatus 500 in this way, the display is not limited to always displaying the name of the object S in the image F (one example of information related to the transmitter 800). It is possible to have the user select whether or not to display the name of the object S, and then display the name of the object S according to the user's selection, or when a plurality of images F are displayed, it is possible to display the name of the object S for only the first image F that includes the object S. Also, it is possible to display the name of the object S only when the size of the displayed object S is a specified size. Similarly, it is possible to display the name of the object S only when the displayed object S is facing a specified direction, such as toward the front. Moreover, it is possible to display the name of the object S only when the image F that includes the object S is displayed for a specified amount of time or longer. Furthermore, in the case where a pointer is prepared that is able to designate a desired location on the screen of the display apparatus 500, it is possible to display the name of the object S only when the user designates the object S with that pointer.

Also, in the second embodiment described above, after the user uses the input unit 202 to input the name of the object S and the display instruction, the extraction unit 207 extracts just the image data that includes the object S from the data stored in the storage unit 205. However, of the image data that includes the object S, the extraction unit 207 could also extract just the image data in which the size of the object S is a specified percentage, such as 40% of the size of the image F, or could extract just the image data in which the object S faces a specified direction, such as toward the front.

Also, after the name of the object S and the display instruction have been input using the input unit 202, in addition to image data that includes the object S, the extraction unit 207 could extract from the information that data stored in the storage unit 205, information that identifies the images F that include the object S. Information that identifies the images F that include the object S could be an image number, or time that the image F was obtained (time the image was taken), etc.

Moreover, in the second embodiment described above, as was explained at the beginning, the attribute information that is stored on the recording medium 900 is the name of the object S (one example of name information) However, as was described in the first embodiment, the name information could be an ID code that can identify the name of the object S.

Also, in the case where the object S is a work of art such as a painting in a museum, or a monument that is a tourist attraction, the information related to the transmitter 800 can be the name of the work of art or monument, or information that can identify the name of the work of art or monument. In this case, by having the image-processing apparatus 200 comprise an information-acquisition unit 214 that acquires detailed information about the work or art or monument via a network based on the name of the work of art or monument or information that can identify the work of art or monument, the information acquired by the information-acquisition unit 214 can be displayed on the display apparatus 500.

Moreover, suppose the case in which the object S is the user's friend and the name of the object S (user's friend) to which the transmitter 800 is attached and the e-mail address of the object S are stored on the recording medium 900 as attribute information.

Incidentally, when the user gives the image data that includes the object S to that friend, the image data is given to the friend as described below.

At that time, the user uses the input unit 202 to input the name of the object S and a send instruction. By doing this, the search unit 206 searches for the image data that includes the object S from the data that is stored on the storage unit 205. The extraction unit 207 extracts the image data that was found by the search unit 206 to include the object S and the attribute information associated with that image data (including the e-mail address of the object S) from the storage unit 205.

The sending unit 215 sends the image data extracted by the extraction unit that includes the object S and the attribute information to the management apparatus that manages the mailbox for the e-mail address of the object S. In the case where part or all of the processes such as the trimming process, size-adjustment process, location-adjustment process and contrast-adjustment process are performed for the image data that includes the object S, instead of the image data extracted by the extraction unit 207, the sending unit 215 can send the image data that was processed by all or part of the processes such as the trimming process, size adjustment process, location-adjustment process and contrast-adjustment process to the management apparatus that manages the mailbox for the e-mail address of the object S.

By doing this, is able to give the friend the image data that include the object S, without having to check the image data that includes the object S (friend) and then send that data to the mailbox for the e-mail address of the object S. Also, the user does not have to store the data on a removable medium such as a CD-ROM and then give that removable medium to the object S.

The e-mail address of the object S does not have to be stored in the storage unit 205 from the recording medium 900, but can also be input by the user to the storage unit 205 using the input unit 202. Also, when the e-mail address of the object S is stored in the storage unit 205, the image data that includes the object S can be sent to the mailbox for the e-mail of the object S without waiting for the send instruction to be input, regardless of whether the user has input a send instruction using the input unit 202. Furthermore, it is possible to send the image data to a terminal of the object S using other application protocol such as HTTP or FTP. The IP address of that terminal or other data necessary for connecting to that terminal is acquired directly from the object S or by using object information. The send unit 215 connects to the terminal automatically or when an instruction is received from the user, and sends the image data that includes the object S.

Moreover, as shown in FIG. 21, in the second embodiment described above, when images F that include the object S are displayed by the display apparatus 500, the display-control unit 208 multiplexes the name-display signal onto the video signal such that the name of the object S is displayed underneath the object S in the image F. However, since information that identifies the range of the object S in the image F is stored in the storage unit 205, the display-control unit can multiplex the name-display signal onto the video signal such that the name of the object S is displayed above the object S or displayed at a specified distance on the right side or like from the object S. Also, the display-control unit 208 can multiplex the name-display signal on the video signal such that the name of the object S is displayed at a location at the top left corner of the image F, etc.

Furthermore, in the second embodiment described above, as was explained at the beginning, image data that is stored on the recording medium 900 is the seven frames of image data shown in FIG. 9, and those seven frames of image data are stored in the storage unit 205. However, there are times when a person other than the user (for example, the parent of the friend of the object S) and the user take images of the object S at the same time.

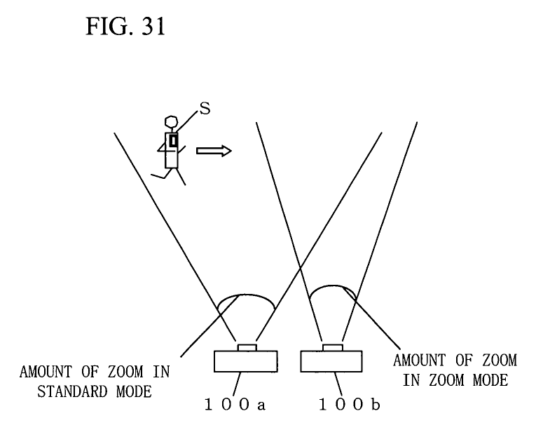

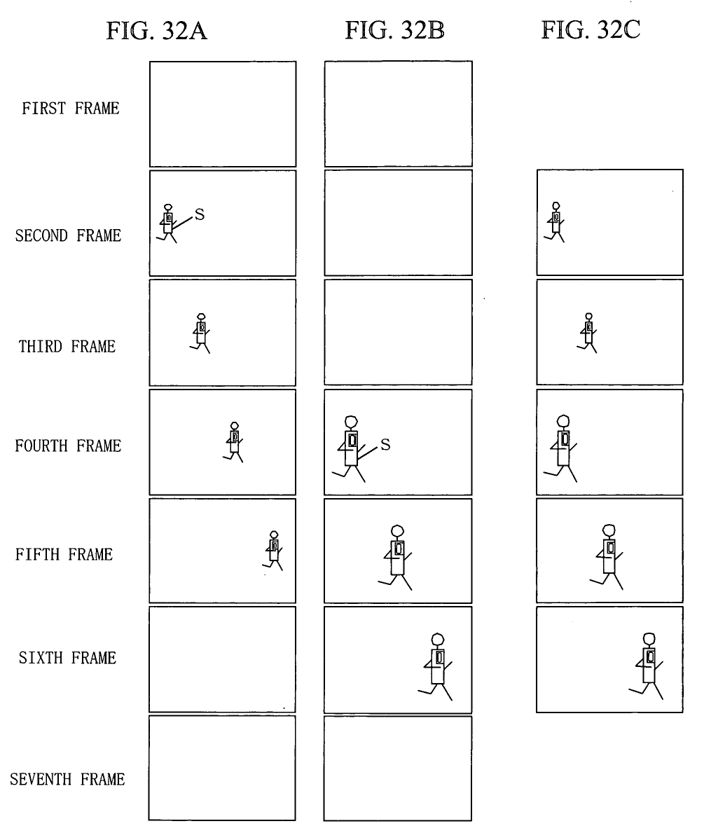

For example, as shown in FIG. 31, the user uses the imaging apparatus 100a to take images of the object S running from the left to the right in FIG. 31 using the zoom amount in the standard mode, and a person other than the user that is next to the user uses the imaging apparatus 100b to take images of the object using the zoom amount in the zoom mode. Here, the seven frames that were obtained by the user are shown in FIG. 32A and the seven frames obtained at the same time by the person other than the user are shown in FIG. 32B. As shown in FIG. 32A, of the seven frames of the images taken and obtained by the user, the object S is included in the second to fifth frames, and as shown in FIG. 32B, of the seven frames of the images taken and obtained by the person that is not the user, the object S is included in the fourth to sixth frames.

As described above, since the user took images using the zoom amount in the standard mode, and the person that is not the user took images using the zoom amount in the zoom mode, as can be clearly seen by comparing FIG. 32A and FIG. 32B, the object S included in the images F taken and obtained by the person that is not the user, is larger than the object S included in the images F taken and obtained by the user.

With the image data for the seven frames shown in FIG. 32A and the image data for the seven frames shown in FIG. 32B stored in the storage unit 205, the user uses the input unit 202 to input the name of the object and a display instruction to display the images that include the object S, which is the user's own child, by the display apparatus 500.

After that, the search unit 206 searches the data stored in the storage unit 205 for image data that includes the object S (user's child). As described above, for the fourth frame and fifth frame the object S is obtained in the images F taken and obtained by the user and also in the images F taken and obtained by the person that is not the user (see FIGS. 32A and 32B). Therefore, the search unit 206 finds the image data for the fourth frame and fifth from taken by the user and the fourth frame and fifth frame taken by the person that is not the user. The extraction unit 207 extracts from the storage unit 205 the image data that was found by the search unit 206 to include the object S, so the display apparatus 500 is able to display two kinds of frames for the fourth frame and fifth frame on the display apparatus 500.

Under these conditions, when the user desires to display the object S as large as possible, in addition to the name of the object S and the display instruction, the user uses the input unit 202 to input an instruction to extract the image data for the images F in which the object S is larger. Here, the information that identifies the size of the object S in the images F is information that identifies the range of the object in the image F. In this case, based on the information that identifies the size of the object S in the images F, the extraction unit 207 extracts the image data for the fourth frame and fifth frame shown in FIG. 32B in which the object S is larger.

By doing this, as shown in FIG. 32C, the images F of the second frame and third frame taken and obtained by the user and the fourth frame and fifth frame taken by the person that is not the user are displayed on the display apparatus 500. In other words, image data for a plurality of images that were obtained at the same time are stored in the storage unit 205, and the images F in which the object S is larger are displayed.

When there is image data for a plurality of images obtained at the same time, the user does not have to use the input unit 202 to input an instruction to extract image data in which the object S is larger, but can use the input unit 202 to input an instruction to extract image data in which the size of the image is a specified size, such as 40 to 60% the size of the image F. Also, instead of inputting an instruction to extract image data, the extraction unit 207 could extract image data in which the size of the object S is a pre-determined size.

Also, as described above, when there is image data for a plurality of images obtained at the same time, and that image data for the plurality of images that were obtained at the same time and information about the direction of the object S in each of those images are stored in the storage unit 205, the extraction unit 207 can extract the image data from the plurality of image data in which the object S is facing a direction designated by the user, or can extract image data in which the object S is facing a pre-determined direction.

When there is a plurality of image data obtained at the same time, and that plurality of image data that were obtained at the same time and information related to the object S in the images based on that plurality of image data are stored in the storage unit 205, the extraction unit 207 only needs to extract image data from among that plurality of image data based on information related to the object that conforms to an instruction from the user, or that conforms to preset rules.

Also, in the second embodiment described above, the object S was the user's child as was explained using FIG. 9, however, the object S is not limited to being one child. For example, the object S could be two or more people such as the use's child and a friend. In this case, image data for the seven images that include the first object Sa and the second object Sb as shown in FIG. 17, and as shown in FIG. 18, information that indicates which images F of the seven images include which objects S and at what time, information about the locations of the transmitters 800 attached to each of the objects S, and information that identifies the range of the objects S in the images are stored on the recording medium 900. The reading unit 204 stores the data stored on the recording medium 900 in the storage unit 205.

Moreover, in the second embodiment described above, the data stored on the recording medium 900 is first stored in the storage unit 205 (one example of a recording medium) that can be accessed directly by each unit of the image-processing apparatus 200, then after that, the search unit 206 searches the data stored in the storage unit 205 for specified data. However, the data stored on the recording medium 900 is not limited to being data that are stored in the recording unit 205. In other words, the search unit 206 can search the data stored on the recording medium 900 for data related to an instruction input by the user, and the extraction unit 207 can extract the data found by the search unit 206 from the recording medium 900. However, in that case, each time the search unit 206 or extraction unit 207 accesses the data stored on the recording medium 900, the reading unit 204 must read the data stored on the recording medium 900 that is mounted in the mounting unit 201.

Also, trimming can be performed based on the size of the displayed imaged and the imaging size. The imaging size is acquired from the object information. When the imaging size is larger than the display size, it can be made to be the same size as the display size by trimming the imaging size. For example, the size of an HDTV is 1920×1080 or 1280×720, and the size of a SDTV is 720×480. When images are taken at the size of the HDTV and displayed at the size of a SDTV, a 720×480 image can be obtained by trimming. In this case, the size of the trimmed image is not limited to being smaller than the size of the displayed image. It is also possible to take an image such that, due to not only trimming but also zooming and location adjustment, is larger than the display size.

Also, the image-processing apparatus 200 of the second embodiment can be used as a home server. A home server stores a lot of data, and has functions for searching, reproducing and editing that data.

Also, the image-processing apparatus 200 of the second embodiment described above can be a portable telephone having each of the functions of the image-processing apparatus 200. Furthermore, the imaging apparatus 100 of the first embodiment, and the image-processing apparatus of the second embodiment can be a portable telephone having the functions of the imaging apparatus 100 and image-processing apparatus 200.

### Third Embodiment

Next, the construction and operation of the imaging apparatus 300 of a third embodiment of the invention will be explained.

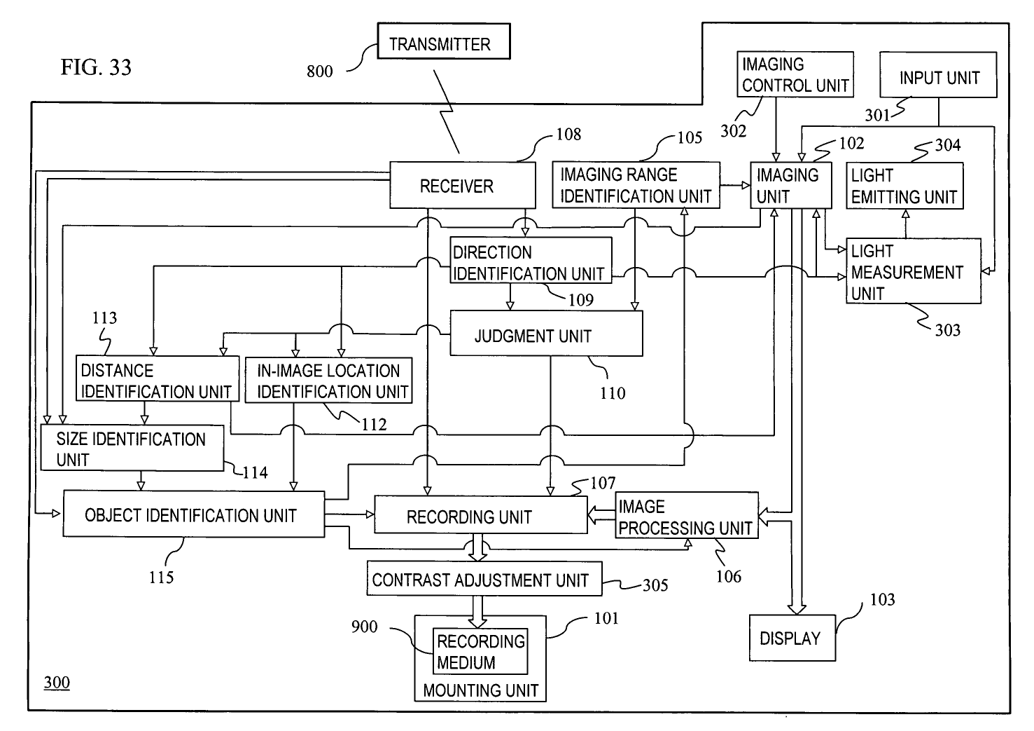

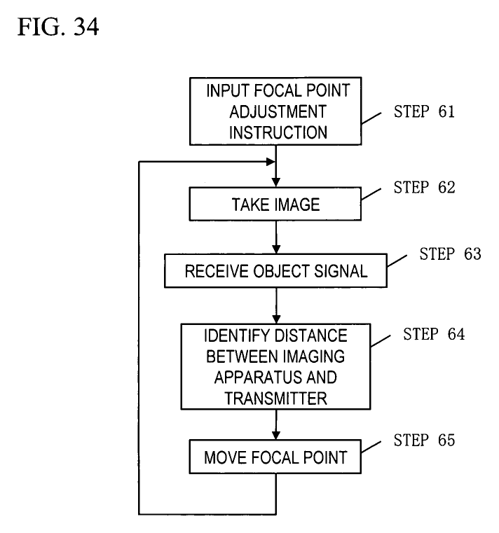

FIG. 33 shows a block diagram of the imaging apparatus 300 of this third embodiment of the invention, and FIGS. 34 to 39 show the operating procedure for the imaging apparatus 300.

As was explained in the second embodiment, images F that were obtained by the imaging apparatus 100 of the first embodiment and that included the object (user's child) to which a transmitter 800 was attached were displayed by a display apparatus 500 after data processing by the image-processing apparatus 200 of the second embodiment.

However, the imaging apparatus 100 may take images of the object S with the focal point not adjusted to the object S, and in that case, the object S will not be clearly displayed on the display apparatus 500. Also, the imaging apparatus 100 may take images of the object S with backlighting or dim lighting, and in that case, the when images F that include the object S are displayed by the display apparatus 500, displayed object S will be dark, or there will be little contrast of object S in the display.

The imaging apparatus 300 of this third embodiment takes into consideration making it easy to see the images F that will be displayed later on the display apparatus 500, and aids the user in taking images. Therefore, as can be clearly seen by comparing FIG. 33 and FIG. 1, in addition to the units of the imaging apparatus 100 of the first embodiment shown in FIG. 1, the imaging apparatus 300 of the third embodiment shown in FIG. 33 comprises an input unit 301, a light-adjustment unit 303, a light-emitting unit 304 and a contrast-adjustment unit 305.

Therefore, the explanation of the imaging apparatus 300 of the third embodiment below will center on the points that differ from the imaging apparatus 100 shown in FIG. 1. Also, to simplify the explanation below, it will be presumed that the transmitter 800 is attached to the object S and that the imaging apparatus 300 takes images of the object S to which the transmitter 800 is attached.

(A) As described above, the imaging apparatus 100 may take images of the object S when the focal point is not set on the object S. In that case the object S will not be displayed clearly by the display apparatus 500.

Therefore, when the user desires to take images of the object S with the focal point set on the object S, the user inputs a focus-adjustment instruction to the input unit 301 (FIG. 34, step 61).

By doing this, as explained for the first embodiment, the imaging unit 102 starts taking images (FIG. 34, step 62), and based on the incident angles A, B of the object signal received by the receiving sensors 108a, 108b (FIG. 34, step 63), the distance-identification unit 113 identifies the distance between the imaging apparatus 300 and the transmitter 800 (FIG. 34, step 64).

After the distance between the imaging apparatus 300 and the transmitter 800 is identified in this way, by changing the position of all or part of the internal lenses, the imaging unit 102 moves the focal point when taking images of the object S to a location separated from the imaging apparatus by the distance identified by the distance identification unit 113 (FIG. 34, step 65).

(B) Also, as was explained above, the imaging apparatus 100 may take images of the object S when there is backlighting or dim lighting. In that case, when the images F that include the object S are displayed by the display apparatus 500, the displayed object S is dark, or the contrast of the object S is less than the standard contrast H, so it is difficult for the user to see the object.

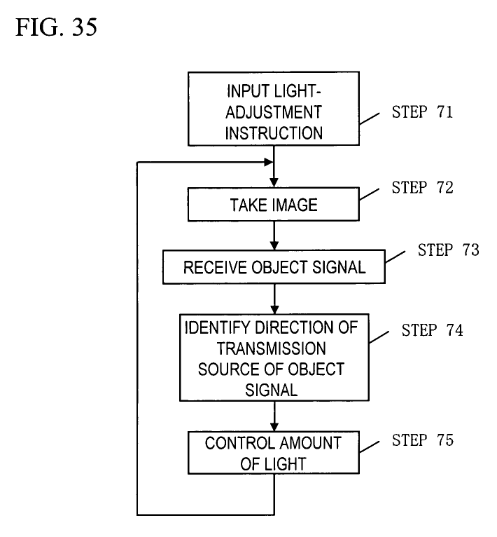

(b-1) Therefore, in order to prevent the displayed object S from being dark, the user inputs a light-adjustment instruction using the input unit 301 (FIG. 35, step 71).

By doing this, the imaging unit 102 starts taking images (FIG. 35, step 72), and then based on the object signal that is received by the receiving sensors 108a, 108b (FIG. 35, step 73), the direction identification unit 109 identifies the direction where the transmitter 800 is located with the location of the imaging apparatus 300 as a reference (FIG. 35, step 74).

After the direction where the transmitter 800 is located with reference to the location of the imaging unit 300 in this way, the light-adjustment unit 303 measures the amount of light that the imaging unit 102 receives from the direction of the transmission source of the object signal. Also, the light-adjustment unit 303 estimates the proper amount of light for the light-emission unit 304 to shine onto the object, and controls the amount of light emitted by the light-emitting unit 304 such that the amount of light received by the imaging unit 102 becomes a preset specified amount, the direction of the light-emitting unit 304, and the location of the light-emitting unit 304 (FIG. 35, step 75).

By doing this, images of the object S are taken with the amount of light at or greater than the preset specified amount (FIG. 35, step 72), so it is possible to prevent the displayed object S from being dark when the images F that include the object S are displayed by the display apparatus 500.

For example, when the imaging apparatus 300 is supported by a tripod and is such that the overall direction and location of the imaging apparatus 300 can be changed, the imaging-control unit 302 can perform control so as to change the overall direction and location of the imaging apparatus 300 or imaging unit 102 such that the amount of light received by the imaging unit 102 is the preset specified amount.

Moreover, when images of the object S are taken when the object S is too bright, the light-adjustment unit 303 controls the aperture of the imaging unit 102 such that the amount of light received by the imaging unit 102 is the preset specified amount.

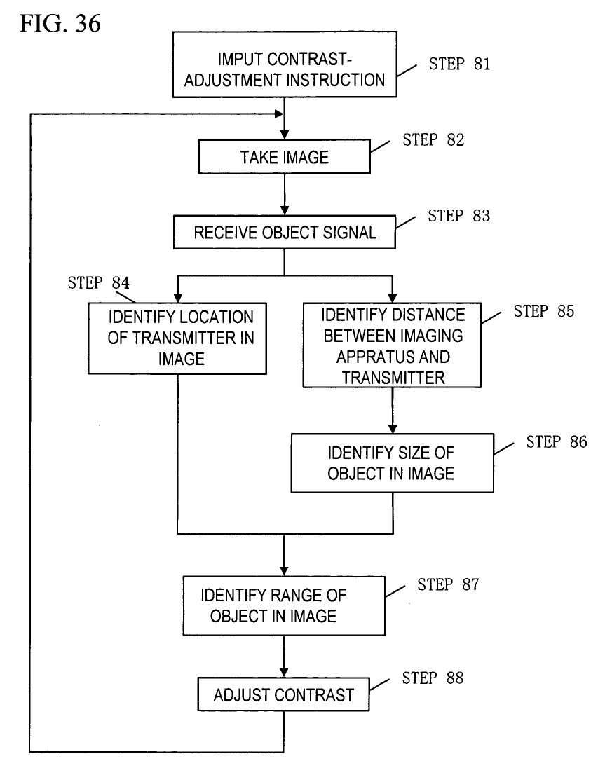

(b-2) On the other hand, when the user desires to take images of the objects with the standard contrast H, the user inputs a contrast-adjustment instruction using the input unit 301 (FIG. 36, step 81).

By doing this, as explained in the first embodiment, the imaging unit 102 starts taking images (FIG. 36, step 82), and based on the object signal that was received by the receiving sensors 108a, 108b (FIG. 36, step 83), the judgment unit 110 determines whether or not the transmitter 800 that transmits the object signal is in that image F. When the judgment unit 110 determines that the transmitter 800 is included, as explained in the first embodiment, the in-image-location-identification unit 112 identifies the location of the transmitter 800 in that image F (FIG. 36, step 84).

Also, as explained in the first embodiment, the distance identification unit 113 identifies the distance between the imaging apparatus 300 and the transmitter 800 (FIG. 36, step 85), and the size-identification unit 114 identifies the size of the object S in the image F based on the distance identified by the distance-identification unit 113, the focal distance when the imaging unit 102 took images of the object S, and the actual size of the object (FIG. 36, step 86).

After the location of the transmitter 800 in the image F is identified and the size of the object S in the image F is identified in this way, as explained in the first embodiment, the object-identification unit 115 takes into consideration the location where the transmitter 800 is attached to the object S and identifies the range of the object S in the image F (FIG. 36, step 87).

After the range of the object S in the image F is identified in this way, the contrast-adjustment unit 305 uses the method performed by the contrast-adjustment unit 212 explained in the second embodiment and performs the contrast-adjustment process for the image F that is input in the recording unit 107 such that the contrast of the range of the object S becomes the standard contrast H (FIG. 36, step 88). Also, the contrast-adjustment unit 305 stores the image data for which the contrast was adjusted on the recording medium 900.

By doing this, the contrast of the object S in the image data recorded on the recording medium 900 becomes the standard contrast H. Therefore, when the image F, which is obtained from the imaging unit 102 after the range of the object S in the image F is identified, is displayed by the display apparatus 500, the objects is displayed with the standard contrast, so the object S is easy for the user to see.

(C) The image data recorded on the recording medium 900 is displayed on the display apparatus 500 after data process by the image-processing apparatus 200. Therefore, in order reduced the processing burden performed by the image-processing apparatus 200, the imaging apparatus 300 can also be constructed as described below.

For example, in the image-processing apparatus 200 of the second embodiment, the search unit 206 searches for image data that includes the object S from the data that was stored in the storage unit 205 from the recording medium 900, the extraction unit 207 extracts the image data found by the search unit 206 from the storage unit 205. However, when just the image data that includes the object S is stored in the storage unit 205, the search operation by the search unit 206 is not necessary, and the processing performed by the image-processing apparatus 200 is reduced.

Therefore, the imaging apparatus 300 of the third embodiment is given the function of recording just the image data that includes the object S on the recording medium 900.

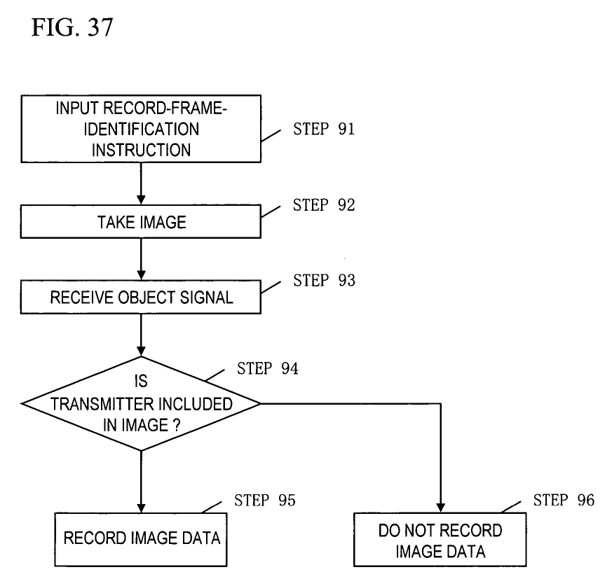

First, when the user desires to record just image data that includes the object S on the recording medium 900, the user inputs a recorded-image-identification instruction using the input unit 301 (FIG. 37, step 91).

By doing this, the imaging unit 102 starts taking images (FIG. 37, step 92), and based on the object signal that was received by the receiving sensors 108a, 108b (FIG. 37, step 93), the judgment unit 110 determines whether or not the transmitter 800 that transmits the object signal is included in that image F (FIG. 37, step 94).

When the judgment unit 110 determines that the transmitter 800 is included, the recording unit 107 records the image data that was determined to include the transmitter 800 on the recording medium 900 (FIG. 37, step 95).

On the other hand, when the judgment unit 110 determines that the transmitter 800 is not included, the recording unit 107 does not record the image data that was determined not to include the transmitter on the recording medium 900 (FIG. 37, step 96).

By doing this, just the image data that includes the object S is recorded on the recording medium 900, so only image data that includes the object S is stored in the storage unit 205. Therefore, it is not necessary for the search unit 206 to perform the search operation, and processing by the image-processing apparatus 200 is reduced.

After just the image data that includes the object S is stored in the storage unit 205, the extraction unit 207 only extracts the image data that includes the object S and the display apparatus 500 only displays images that include the object S. By doing this, the user can only see images F that include the object S, however since the images F before and after the displayed images F are not displayed, it may not always be possible for the user to know what the displayed moving images are.

For example, supposing that the user took images of a basketball event at the sports festival in which the object S participated. In that case, as a result of recording just the image data that includes the object S on the recording medium 900, only the images F that include the object S are displayed, and the images F before and after those images F are not displayed. Therefore, the user is unable to gain a complete understanding of the basketball event.

Therefore, in order to make it possible to display not only the images F that include the object S by also a specified number of images before and after those images F (for example, the number of images corresponding to one minute before and after the images F), the recording unit 107 records image data for a specified number of images before and after the images that were determined by the judgment unit 110 to include the object S on the recording medium 900. In this case, the imaging apparatus 300 comprises a temporary-storage unit that temporarily stores image data for a specified number of images F.

After image data for a specified number of images F before and after the images F determined by the judgment unit 110 to include the object S are recorded on the recording medium 900 in this way, the specified number of images F can be displayed and the user is able to gain a better understanding of what the moving images of the object S are.

Also, in (C) above, image data that was determined to include the object S by the judgment unit 110 was recorded on the recording medium 900 by the recording unit 107. However, as was explained in (b-2), it is possible for the object-identification unit 115 to identify the range of the object S in the image F. Therefore, the recording unit 107 can also record just image data for the object S and the area within a specified distance range from the object S in the image F on the recording medium 900. By having the recording unit 107 record just image data for the object S and the area within a specified distance range from the object S on the recording medium 900 in this way, the trimming process performed by the image processing apparatus 200 can be reduced.

Therefore, when the user desires to record just the object S and the area within a specified distance range from the object S in the image F that was determined by the judgment unit 110 to include the object S on the recording medium 900, the user inputs a recorded-area-identification instruction using the input unit 301. By doing so, the recording unit 107 records just the image data for an area within a specified distance range from the object S in the image F that was identified by the object-identification unit 115 on the recording medium 900.

Also in (C) above, the case was explained in which, of the image data for images F taken by the user, just the image data that includes the object S is recorded on the recording medium 900. However, the imaging unit 102 only performs the imaging process when it is determined that the object S is included in the image F to be taken.

More specifically, when the imaging unit 102 has not taken any images and the receiving sensors 108a, 108b receive the object signal, as described above, the judgment unit 110 determines whether or not the transmitter 800 that transmits the object signal is included in the image F obtained by the imaging unit 102. When the judgment unit 110 determines that the transmitter 800 is included, it sends an imaging instruction to the imaging unit 102. After receiving the imaging instruction, the imaging unit 102 takes images of the object S.

Instead of sending an imaging instruction only when it is determined that the transmitter 800 is included in the image F, the judgment unit 110 can also send an imaging instruction even for a specified amount of time after the transmitter 800 is no longer included. In that case, images continue to be taken for a specified amount of time after it is determined that the transmitter 800 is included, so it is possible to see the images F for which it was determined that the transmitter 800 was included and images for which the transmitter 800 is not included.

Incidentally, as was described above, the object-identification unit 115 can identify the range of the object S in the image F obtained from the imaging unit 102. Therefore, based on the range of the object S, the imaging unit 102 can also take images of just the object S and an area within a specified distance range from the object S.

Therefore, when an imaging-area-identification instruction is input using the input unit 301, and when the judgment unit 110 determines that the object S is included in the image F to be taken by the imaging unit 102, the imaging-range-identification unit 105 identifies the imaging range of the imaging unit 102 such that images are taken only of the object S identified by the object-identification unit 115 and an area within a specified distance range from the object S. By doing this, the imaging unit 102 takes images of only the object S and the area within a specified distance range from the object S. In this case as well, the trimming process performed by the image-processing unit 200 is reduced.

Also, in (C) above, the image-processing unit 106 can perform image processing for all of the images F obtained from the imaging unit 102 according to the MPEG standard or the like, or can perform image processing for an image F just when the judgment unit 110 determines that the object S is included in that image F.

(D) Also, even though the object S is included in the image F that is obtained from the imaging apparatus 100, the location of the object in that image F may not be fixed. In other words, when the object S is displayed by the display apparatus 500, the object S may be displayed on the right side of the screen of the display apparatus 500, or may be displayed on the left side. Therefore, when the user views the object S displayed by the display apparatus 500, the user may have to change the line of sight, and in that case, the object S becomes difficult to see.

The imaging apparatus 300 of this third embodiment when supported by a tripod or the like has a function that allows it to take images of the object S such that object S is located in the center of the image F.

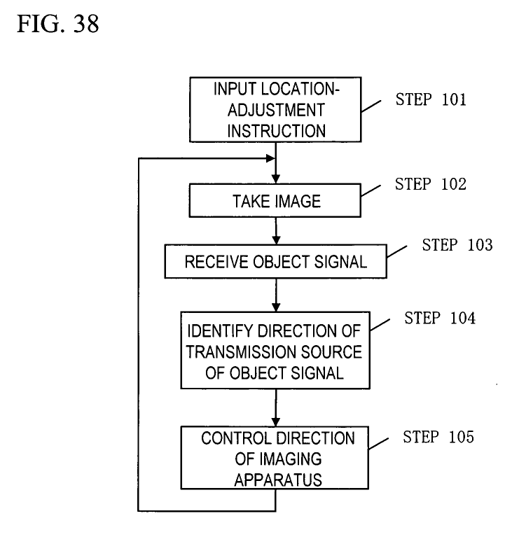

Therefore, when the user desires to take images of the object S such that the object S is located in the center of the image F, the user inputs a location-adjustment instruction using the input unit 301 (FIG. 38, step 101).

By doing this, the image unit 102 starts taking images (FIG. 38, step 102), and after the receiving sensors 108a, 108b receive the object signal (FIG. 38, step 103), the direction-identification unit 109 identifies the direction where the transmitter 800 is located with reference to the location of the imaging unit 300 (FIG. 38, step 104).

After the direction where the transmitter 800 is located with reference to the location of the imaging apparatus 300 is identified, the imaging-control unit 302 controls the direction and location of the imaging unit 102 such that the identified range is the imaging range (FIG. 38, step 105).

By doing this, the imaging unit 102 is able to take images such that the object S is located in the center of the image F (FIG. 38, step 102), and it becomes easy for the user to see the object S when the image F that includes the object S is later displayed by the display apparatus 500.

In (D) above, the case in which the imaging apparatus 300 was supported by a tripod was explained, however, the imaging apparatus 300 could also be located on a rail that runs parallel to a straight course of a track and field stadium and could travel along that rail.

Here, the case is supposed in which the imaging apparatus 300 is located such that it can move along a rail and takes images of the object S that runs along the straight course and to which the transmitter 800 is attached. In this case, the imaging-control unit 1402 controls the direction and location of the imaging unit 102 such that the direction identified by the direction-identification unit 109 is the imaging range. Also, the imaging unit 102 moves the entire imaging apparatus 300 or the imaging unit 102 in the direction that the transmitter 800 (object S) moves at the same speed as the speed of the transmitter 800, or in other words the speed of the object S that was obtained by analyzing the location of the transmitter 800 in the images F identified by the in-image location identification unit 112.

By doing this, when the object S runs along the straight course, the imaging unit 102 is able to take images such that the object S is located in the center of the image F.

In (D) above, the imaging unit 102 controls the direction of the imaging unit 102 such that the direction identified by the direction identification unit 109 becomes the imaging range. However, when the imaging apparatus 300 is constructed such that the location, for example the height of the imaging unit 102, can change, the imaging-control unit 302 can control the location such as the height of the imaging apparatus 300 in the same way as it controlled the location of the imaging unit 102 such that the location identified by the direction-identification unit 109 becomes the imaging range.

(E) Also, even though the object S is included in images F obtained from the imaging apparatus of the first embodiment, the size of the object S in the images F may not be constant. In other words, when an image F that includes the object S is displayed by the display apparatus 500, the object S may be displayed at a small size that is about 10% the size of the screen of the display apparatus 500, or may be displayed at a large size that is about 90% the size of the screen. When the object S is displayed at a size that is 10% to 90% the size of the screen of the display apparatus 500, it becomes difficult for the user to see the object S.

The imaging apparatus 300 of this third embodiment has a function that allows it to take images of the object S such that the size of the object S in the image F is a specified size such as 40% the size of the image F.

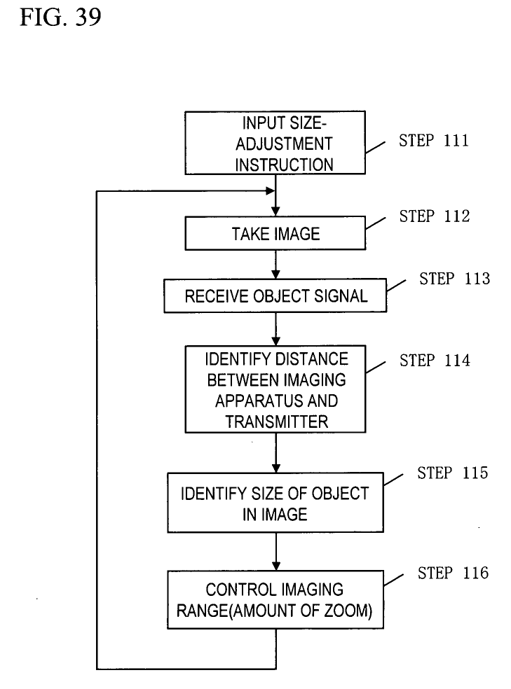

Therefore, when the user desires to take images of the object S such that it is a specified size in the image F, the user inputs a size-adjustment instruction using the input unit 301 (FIG. 39, step 111).

As described above, the imaging unit 102 starts taking images (FIG. 39, step 112), and after the receiving sensors 108a, 108b receive the object signal (FIG. 39, step 113), the judgment unit 110 determines whether or not the transmitter 800 that transmits the object signal is included in that image F. When the judgment unit 110 determines that the transmitter 800 is included, the distance-identification unit 113 identifies the distance between the imaging apparatus 300 and the transmitter 800 (FIG. 39, step 114), and the size-identification unit 114 identifies the size of the object S in that image F based on the distance identified by the distance-identification unit 113, the focal distance when the imaging unit 102 took images of the object S, and the actual size of the object (FIG. 39, step 115).

After the size of the object S in the image F is identified in this way, when it is presumed that the distance between the imaging apparatus 300 and the transmitter does not change, after the size of the object in the image F is identified such that size of the object S in the image F is a specified size, for example 40% the size of the image F when images of the object S are taken after that, the imaging-range-identification unit 105 controls the imaging range when the imaging unit 102 takes images of the object S (amount of zone used when the imaging unit takes images of the object S) (FIG. 39, step 116).

In this way, the imaging unit 102 is able to take images of the object S such that the size of the object S in the image F is a specified size, for example 40% the size of the image F, and when the image F that includes the object S is later displayed by the display apparatus 500, the user can easily see the object S.

In (E) above, when the judgment unit 110 determined that the transmitter 800 was included in the image F, after the image F that was determined to include the transmitter 800 is obtained, the imaging-range-identification unit 105 controls the imaging range when images are taken of the object S (amount of zoom used when the imaging unit 102 takes images of the object S). However, as was described above, it is possible for the object-identification unit to identify the range of the object S in the image F. Therefore, instead of adjusting the imaging range (amount of zoom) when taking images of the object S, it is possible for the image-processing unit 106 to process the image data of the image F based on the range of the object S in the image F identified by the object-identification unit 115 such that the size of the object S obtained by the imaging unit 102 is a specified size, for example 40% the size of the image F.

By doing this, when the image F that includes the object is displayed later by the display apparatus 500, the user is able to see the object S at a fixed size, and thus it is easy to see the object S.

In the third embodiment described above, as was explained in (A) to (E) above, there user uses the input unit 301 to input the focal-point adjustment instruction, light-adjustment instruction, contrast adjustment instruction, recorded-image-identification instruction, imaging-area-identification instruction, imaging-range-identification instruction, location-adjustment instruction or size-adjustment instruction. However, the user can also input a plurality of the eight instructions using the input unit 301 to simultaneously obtain a plurality of the effects described in (A) to (E) above.

For example, the user can input the focal-point-adjustment instruction, light-adjustment instruction and recorded-image-identification instruction using the input unit 301, and together with being able to take images of the object S with the focal point set on the object S, and at the preset specified amount of light, it is possible to record just the image data for images F that include the object S on the recording medium 900.

When the transmitter 800 is set at a specified location that is separated from the object S by a specified distance in this way, by including the positional relationship between the transmitter 800 and the object S in the object information, it is possible for the direction identification unit 109 to use that object information to identify the direction of the object S with respect to the imaging apparatus 300. Similarly, by using that object information, the in-image-location-identification unit 112 can identify the location of the object S in the image F, the distance-measurement nit 113 can identify the distance between the object and the imaging apparatus 300, the size-identification unit 114 can identify the size of the object in the image F and the object-identification unit 115 can identify the range that the object occupies in the image S.

Also, the imaging-range-identification unit 105, image-processing unit 106, direction-identification unit 109, judgment unit 110, in-image-location identification unit 112, distance-identification unit 113, size-identification unit 114, object-identification unit 115, imaging-location-identification unit 116, time-measurement unit 118, time-measurement unit 120, transmitter-identification unit 121, light-adjustment unit 303, light-emission unit 304, contrast-adjustment unit 305 and contrast-adjustment unit 212 in the imaging apparatus 100 of the first embodiment and the imaging apparatus 300 of the third embodiment can be entirely or partially constructed using hardware, or constructed using software.

Similarly, the storage unit 205, search unit 206, extraction unit 207, display-control unit 208, trimming-adjustment unit 209, size-adjustment unit 210, location-adjustment unit 211, contrast-adjustment unit 212, memory unit 213, sending unit 215, in-image-location-identification unit 112, distance-identification unit 113, size-identification unit 114, object-identification unit 115, time-measurement unit 118 and time-measurement unit 120 in the image-processing apparatus 200 of the second embodiment can be entirely or partially constructed using hardware, or constructed using software.

Furthermore, a program can be executed on a computer that makes that computer function entirely or partially as the imaging range identification unit 105, image-processing unit 106, direction identification unit 109, judgment unit 110, in-image location identification unit 112, distance-identification unit 113, size identification unit 114, object-identification unit 115, imaging location identification unit 116, time-measurement unit 118, time-measurement unit 120, transmitter-identification unit 121, light-adjustment unit 303, light-emission unit 304, contrast-adjustment unit 305 and contrast adjustment unit 212 in the imaging apparatus 100 of the first embodiment and the imaging apparatus 300 of the third embodiment.

Similarly, a program can be executed on a computer that makes that computer function entirely or partially as the storage unit 205, search unit 206, extraction unit 207, display-control unit 208, trimming adjustment unit 209, size-adjustment unit 210, location-adjustment unit 211, contrast-adjustment unit 212, memory unit 213, sending unit 215, in-image-location-identification unit 112, distance-identification unit 113, size-identification unit 114, object-identification unit 115, time-measurement unit 118 and time-measurement unit 120 in the image-processing apparatus 200 of the second embodiment.

Specific examples of the form for using that program could include recording that program on a recording medium such as a CD-ROM, and supplying that recording medium on which that program is recorded, or transmitting that program via a communication means such as the Internet. Also, the program can be installed in the computer.

### Fourth Embodiment

As was explained in the first embodiment, it is possible to send image data and object information that is associated with that image data to the image-processing apparatus 200 or terminal via a network. In the first embodiment, the imaging apparatus 100 performed this transmission, however it is not limited to this. For example, it is also possible for a computer that is connected to the imaging apparatus by a USB or IEEE1394 bus to perform that transmission. That computer reads the image data and object information from the recording medium 900 that is mounted in the imaging apparatus 100. That computer sends the image data and object information that were read to a terminal that is connected over a network as needed or when there is a request from the terminal.

As was explained in the second embodiment, the image data and object information that are sent can be received by the image-processing apparatus 200 using an information-acquisition unit 214.

The function of the image-processing apparatus 200 can be provided by a personal computer having a hard disc, or in a various products such as a DVD recorder, DVD player, set-top box, television or the like.

It is also possible to display image data based on the object information read from the recording medium 100 or acquired over the network even on a reproduction apparatus such as a DVD player that does not have a function for recording edited images. The reproduction apparatus generates a reproduction signal from the image data that was extracted based on the search results.

By using broadband communication technology such as ADSL in the communication between apparatuses that send and receive image data and object data via a network, it is possible to distribute video in realtime or by streaming. The image-processing apparatus 200 stores the moving-image data and object information acquired from the imaging apparatus 100 or computer connected to the imaging apparatus 100 via a broadband network in a buffer. While the data is being stored, the moving-image data and object information are read from the buffer and the frames of the moving-image data are searched based on the object information. The image-processing apparatus 200 extracts frame data from the moving-image data based on the search results. Also, it generates a reproduction signal from the extracted data and outputs it to the display apparatus 500. By automatically performing the processing necessary for this kind of display while there is still data remaining in the buffer, it is possible to display the edited video in realtime.

In the example of a parent using the imaging apparatus 100 to take images of his/her child at a kindergarten sports festival, the video of just the child or close-up video of the child is displayed on the display apparatus 500 located at the user's home, so the family members remaining at home can also immediately know how the child is performing.

In the case where images of the same object are taken by a plurality of imaging apparatuses, data of the moving images taken by each of the imaging apparatuses can be combined as shown in FIG. 32, and can be displayed in realtime on the display apparatus 500. As in the case when images are not displayed in realtime, the search unit 206 searches for image data for a plurality of images that include the same object, and the extraction unit selects data from among the frames that correspond to the found data to be extracted.

As in the case of sending image data from the image-processing apparatus 200 to the terminal, the IP address of the image-processing apparatus 200 where the image data of images taken by the imaging apparatus 100 are to be sent and other necessary data for connecting to the image-processing apparatus 200 are acquired from the object information itself or by using the object information.

Also, when moving image data from the imaging apparatus 100 via the network, it is not necessary to collect the recording medium from a fixed camera that is set up at a certain location, so it becomes easer to use a fixed camera as the imaging apparatus 100.

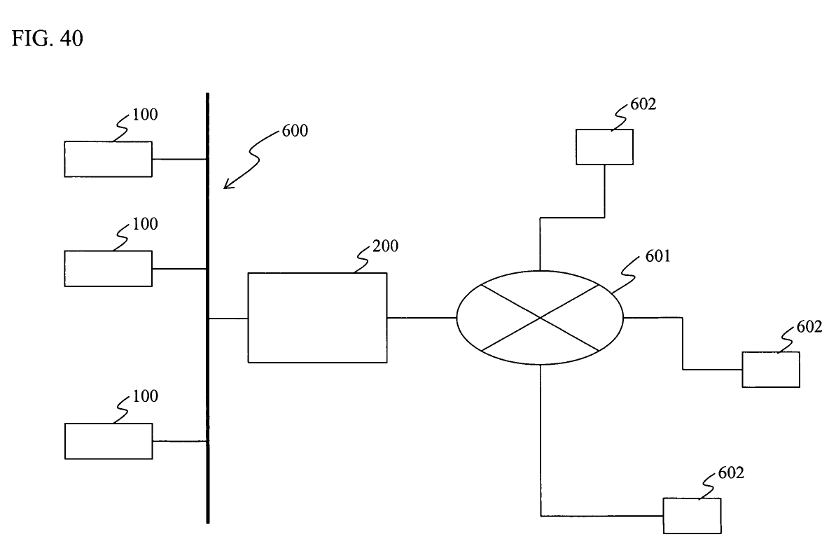

The imaging range of a fixed camera is limited, so in comparatively large places where people gather such as an amusement park, kindergarten or park, fixed cameras are often set up at several places. In the system shown in FIG. 40, a plurality of imaging apparatuses 100 are connected to one image-processing apparatus 200 via a local area network. The image-processing apparatus 200 acquires image data and object information that is associated with that image data from each imaging apparatus 100 via a network 600.

Moreover, in this system, a plurality of terminals 602 are connected to the image-processing apparatus 200 via a network 601. The sending unit 215 of the image-processing apparatus 200 distributes video to the terminals 602 via that network 601. The search unit 206 searches the acquired image data for image data with which the object information that corresponds to the terminals 602 is associated. The extraction unit 207 extracts image data for the terminal 602 of each distribution destination based on the search results. The extracted image data is sent to each corresponding terminal 602. In the case where a plurality of objects S in different locations are taken by a plurality of imaging apparatuses 100, video that includes an object S is distributed to the terminal 602 that corresponds to that object S. Video is created for each object S by image processing, so it is not necessary to select or prepare an imaging apparatus 100 for each object S.

Furthermore, the video can be distributed to the terminals 602 after performing contrast adjustment, location adjustment, size adjustment and trimming adjustment. When performing this adjustment by image processing, the same adjustment is performed optically so the need to control each imaging apparatus 100 is decreased. Therefore, it is possible to build an inexpensive system.

Also, by using this kind of image-distribution system it becomes easy to perform a service of providing images to visitors to an event site, amusement park, etc. A plurality of fixed cameras that are located at the site that provides the service are used as imaging apparatuses 100, and the transmitters 800 are attached to the visitors like a name tag. The service provider uses a database to associate the ID data of the transmitters 800 that were given to the visitors with data that identifies the visitors' terminals 602. The transmitter 800 transmits an object signal that includes the ID data for the transmitter 800 as object information. The ID data for the transmitter 800 is handled as ID data for the visitor carrying the transmitter 800 at the site of the service provider. The image-processing apparatus 200 searches the image data with which the object information that corresponds to the ID data of the transmitter 800 given to the visitor is associated. The extractor 207 extracts image data for the terminals 602 of the visitors based on the search results. By using the image-distribution system like this, images of the visitor are provided to the terminals 602 of the visitors. The visitors can then view the images on a computer or portable telephone that is specified as the terminal 602.

This kind of service can also be provided by recording the image data extracted for each visitor on a recording medium that is distributed to the visitors or on a recording medium that is brought by the visitor. When the visitor leaves the site, the transmitter 800 is collected and the ID data for that transmitter 800 can be used to record the extracted image data on the recording medium. Furthermore, the extracted image data can be provided to the visitor from a website. ID data for accessing the image data to be provided to the visitor is given to the visitor. The image data in which the visitor is included is sent to the web client only after the web server identifies the visitor based on the ID data given to that visitor.

In the example shown in FIG. 40, searching and extracting were performed by only one image-processing apparatus 200, however it is not limited to this. Each of the terminals could also be used as an image-processing apparatus 200. Or in other words, search units 206 and extraction units 207 of the image-distribution system are installed in each of the terminals 602. In this case, the image data obtained from each of the imaging apparatuses 100 are sent to the terminals 602. Since the distributing side only needs to send the image data of the images taken and the object information associated with that image data, the distribution burden is lightened.

Also, the system and apparatus explained in this fourth embodiment also can be embodied in a computer using a program. By having the CPU of the computer perform operations according to instructions in the program, and control input and output of the memory and peripheral devices, the computer can function as the system and apparatuses.

When the imaging apparatus of this invention records image data that includes the object, it can associate metadata of that object with the image data, and in addition to an imaging apparatus such as a portable video camera or digital still camera, the invention is useful in an image-processing apparatus that edits and displays images, and an image-distribution system.

What is claimed is:

1. An imaging apparatus comprising:
an imaging unit;
a receiving unit that is operable to receive an object signal from outside;
a judgment unit that is operable to determine whether or not the location of a transmitter that transmits the object signal that is received by the receiving unit is included in image data obtained by the imaging unit; and
a recording unit that is operable to record object information that is included in the object signal, with the image data that is obtained by the imaging unit and with which the object information is associated when it is determined that the location of the transmitter is included in the image data.

2. The imaging apparatus of claim 1 wherein;
the receiving unit directly receives the object signal from the transmitter; and further comprises
a direction-identification unit that is operable to identify a direction to the location of the transmitter based on the object signal received by the receiving unit; and wherein
the judgment unit determines whether or not the location of the transmitter is included in the image data based on the imaging range when the imaging apparatus takes an image of the object, and the direction identified by the direction-identification unit.

3. The imaging apparatus of claim 1 further comprising:
an imaging-location-identification unit that is operable to identify a current location; and wherein
the transmitter has a function of identifying a location of the transmitter and transmits transmission-location information that indicates the location of that transmitter as the object signal; and
the judgment unit determines whether or not the location of the transmitter is included in image data based on the imaging range when the imaging unit takes an image of the object, current location identified by the imaging-location-identification unit, and object signal received by the receiving unit.

4. The imaging apparatus of claim 1 further comprising
a response-request-signal-transmission unit that is operable to transmit a specified response-request signal; an wherein
the transmitter transmits the object signal when the response-request signal is received.

5. The imaging apparatus of claim 1 wherein
the transmitter is attached to an object, and
the recording unit records location information, which identifies a location of the object in an image based on the image data obtained from the imaging unit, with associated with the image data.

6. The imaging apparatus of claim 1 wherein
the transmitter is attached to an object, and
the recording unit records size information, which identifies a size of the object in an image based on the image data obtained from the imaging unit, with associated with the image data.

7. The imaging apparatus of claim 1 wherein
the transmitter is attached to an object, and
the object information is name information that identifies a name of the object.

8. The imaging apparatus of claim 1 wherein
the recording unit stores the object information included in the object signal, with the image data that is obtained from the imaging unit and with which the object information is associated, on a recording medium.

9. An image-processing apparatus comprising:
a search unit that is operable to search the image data stored on the recording medium of claim 8 for image data with which object information that is input by a user is associated; and
an extraction unit that is operable to extract image data that is found by the search unit.

10. The image-processing apparatus of claim 9 further comprising a display-control unit that includes the object information in the image data extracted by the extraction unit.

11. The image-processing apparatus of claim 10 wherein
the transmitter is attached to an object;
location information that identifies a location of the object in an image based on the image data with which the object information is associated is also stored on the recording medium; and
the display-control unit includes the object information in the image data such that the object information is displayed together with the object in the image.

12. The image-processing apparatus of claim 9 wherein
the transmitter is attached to an object; and
together with location information, which identifies a location of the object in an image based on the image data with which the object information is associated, size information, which identifies a size of the object in the image, is also stored on the recording medium; and further comprises
a trimming-adjustment unit that is operable to remove the image data based on the location information and the size information such that of the image, at least the area that includes the object remains.

13. The image-processing apparatus of claim 12 further comprising a size-adjustment unit that is operable to adjust a size of the image based on image data that is processed by the trimming-adjustment unit.

14. The image-processing apparatus of claim 12 further comprising a location-adjustment unit that is operable to adjust a location of an object in image data that is processed by the trimming-adjustment unit.

15. The image-processing apparatus of claim 9 wherein
the transmitter is attached to an object; and
together with location information, which identifies a location of the object in an image based on the image data with which the object information is associated, size information, which identifies a size of the object in the image, is also stored on the recording medium; and further comprises
a size-adjustment unit that is operable to process the image data based on the location information and the size information such that the object in the image becomes a specified size with respect to the image.

16. The image-processing apparatus of claim 9 wherein
the transmitter is attached to an object; and
together with location information, which identifies a location of the object in an image based on image data with which the object information is associated, size information, which identifies a size of the object in the image, is also stored on the recording medium; and further comprises
a location-adjustment unit that is operable to process the image data based on the location information and the size information, such that the object is displayed at a specified location in the image.

17. The image-processing apparatus of claim 9 wherein
the transmitter is attached to an object; and
together with location information, which identifies a location of the object in an image based on image data with which the object information is associated, size information, which identifies a size of the object in the image, is also stored on the recording medium; and further comprises
a contrast-adjustment unit that is operable to adjust overall contrast of the image based on contrast in a range occupied by the object in the image obtained based on the location information and size information.

18. The image-processing apparatus of claim 9 further comprising a sending unit that is operable to send image data extracted by the extraction unit, or the image data for which certain process has been performed to a management apparatus related to the object information.

19. The image-processing apparatus of claim 9 wherein
the image data is data of moving images having a plurality of frames, and
the extraction unit selects from frames corresponding to data found when the search unit searches for a plurality of image data that include the same object, a frame for data to be extracted.

20. The image-processing apparatus of claim 19 wherein
the extraction unit selects from frames included in the plurality of image data and obtained at the same time, a frame corresponding to the time for data to be extracted.

21. An image-processing apparatus comprising:
a unit that is operable to read image data and object information associated with that image data from the recording medium of claim 8; and
a unit that is operable to display the image data based on the object data that is read.

22. An apparatus that comprises:
an imaging unit;
a receiving unit that is operable to receive an object signal from outside;
a judgment unit that is operable to determine whether or not a location of a transmitter that transmits the object signal that is received by the receiving unit is included in image data obtained by the imaging unit; and
a recording unit that is operable to record the object information included in the object signal, with the image data that is obtained by the imaging unit and with which the object information is associated when it is determined that the transmitter is included in the image data;
and wherein sends the image data and object information that is associated with the image data via a network.

23. An image-processing apparatus comprising:
a unit that is operable to acquire via a network image data and object information that is associated with that image data from the apparatus of claim 22; and
a unit that is operable to display image data based on the acquired object information.

24. An image-distribution system of distributing images to a plurality of terminals connected via a network and comprising:
an imaging unit;
a receiving unit that is operable to receive an object signal from outside;
a judgment unit that is operable to determine whether or not a location of a transmitter that transmits the object signal that is received by the receiving unit is included in image data obtained by the imaging unit;
a recording unit that is operable to record the object information included in the object signal, with the image data that is obtained by the imaging unit and with which the object information is associated when it is determined that the transmitter is included in the image data;
a unit that is operable to acquire the image data that is recorded by in the recording unit and object information associated with the image data;
a search unit that is operable to search the acquired image data for image data with which object information corresponding to a terminal is associated; and
an extraction unit that is operable to extract the image data found by the search unit for each terminal.

25. An imaging apparatus comprising:
an imaging unit;
a receiving unit that is operable to receive an object signal from outside; and
a distance-identification unit that is operable to identify, based on an object signal received by the receiving unit, a distance to the transmitter that transmits the object signal;
and wherein the imaging unit sets the focal distance when the imaging unit takes an image of the object based on the distance identified by the distance-identification unit.

26. An imaging apparatus comprising:
an imaging unit;
an light-emitting unit that is operable to emit light;
a receiving unit that is operable to receive an object signal from outside; and
a direction-identification unit that is operable to identify a direction of the transmitter that transmits the object signal that is received by the receiving unit;
and wherein the imaging unit comprises a light-adjustment unit that is operable to control at least one of the amount of light emitted by the light-emitting unit and direction and location of the light-emitting unit such that the amount of light received by the imaging unit from the direction identified by the direction-identification unit becomes a specified amount.

27. An imaging apparatus comprising:
an imaging unit;
a receiving unit that is operable to receive an object signal from outside; and
a direction-identification unit that identifies a direction of a transmitter that transmits the object signal received by the receiving unit;
and wherein an imaging-control unit that is operable to control at least the imaging direction or imaging location of the imaging unit based on the direction identified by the direction-identification unit.

28. An imaging apparatus comprising:
an imaging unit;
a receiving unit that is operable to receive an object signal from outside;
a direction-identification unit that is operable to identify a direction of a transmitter that transmits the object signal that is received by the receiving unit; and
a light-adjustment unit that is operable to control the aperture such that the amount of light received by the imaging unit from the direction identified by the direction-identification unit becomes a specified amount.

29. An imaging apparatus comprising:
an imaging unit;
a receiving unit that is operable to receive an object signal from outside;
a direction-identification unit that is operable to identify a direction of a transmitter that transmits the object signal that is received by the receiving unit;
a judgment unit that is operable to determine, based on the object signal identified by the direction-identification unit, whether or not the transmitter that transmits the object signal and that is attached to a certain object is included in the image of image data obtained from the imaging unit; and
a contrast-adjustment unit that is operable to adjust contrast of the image of the image data obtained from the imaging unit when it is determined that the transmitter is included in the image.

30. An imaging apparatus comprising:
an imaging unit;
a receiving unit that is operable to receive an object signal from outside;
a judgment unit that is operable to determine whether or not a transmitter that transmits the object signal and that is attached to a certain object is included in the image data obtained from the imaging unit;
an in-image-location-identification unit that is operable to identify a location of the object in an image based on the image data obtained from the imaging unit;
a size-identification unit that is operable to identify a size of the object in the image based on image data obtained from the imaging unit; and
a contrast-adjustment unit that is operable to identify a range in the imaged occupied by the object based on the location identified by the in-image-location-identification unit and size identified by the size-identification unit when the judgment unit determines that the transmitter is included in the image data, and to adjust contrast of the image in the range.

31. The imaging apparatus of claim 30 wherein an area in the image exists within a specified distance range from the range occupied by the object in the image.

32. An imaging apparatus comprising:
an imaging unit;
a receiving unit that is operable to receive an object signal from outside; and
a judgment unit that is operable to determine, based on the object signal received from the receiving unit, whether or not a transmitter that transmits the object signal is included in an image based on image data obtained from the imaging unit;
and wherein the imaging unit takes images of the object when the transmitter is included in the image.

33. The imaging apparatus of claim 32 wherein
the transmitter is attached to a certain object; and further comprises
an in-image-location-identification unit that is operable to identify a location of the object in an image based on image data obtained from the imaging unit; and
a size-identification unit that is operable to identify a size of the object in the image based on the image data obtained from the imaging unit;
and wherein the imaging unit takes images of the object and an area existing within a specified distance range from that object based on the location identified by the in-image-location-identification unit and size identified by the size-identification unit.

34. An imaging apparatus comprising:
an imaging unit;
a receiving unit that is operable to receive an object signal from outside;
a direction-identification unit that is operable to identify a direction of a transmitting source of the object signal based on the object signal received by the receiving unit; and
an imaging-control unit that is operable to control at least an imaging direction or imaging location of the imaging unit based on the direction identified by the direction-identification unit.

35. An imaging apparatus comprising:
an imaging unit;
a receiving unit that is operable to receive an object signal from outside; and
a judgment unit that is operable to determine, based on the object signal received by the receiving unit, whether or not a transmitter that is attached to a certain object and transmits the object signal is included in an image based on image data obtained from the imaging unit;
and wherein the imaging unit controls an imaging range such that the size of the object in the image of the image data to be taken is a specified size, when the transmitter is included in the image.

36. The imaging apparatus of claim 35 comprising:
an imaging unit;
a receiving unit that is operable to receive an object signal from outside;
a judgment unit that is operable to determine whether or not a transmitter that is attached to an object and transmits the object signal is included in an image based on image data obtained from the imaging unit when the object signal is received by the receiving unit; and
a size-identification unit that is operable to identify a size of the object in the image based on the image data obtained from the imaging unit;
and wherein the imaging unit takes images in an imaging range based on the size identified by the size-identification unit.

37. An imaging apparatus comprising:
an imaging unit;
a receiving unit that is operable to receive an object signal from outside;
a judgment unit that is operable to determine whether or not a transmitter that is attached to a certain object and transmits the object signal is included in an image data obtained from the imaging unit when the object signal is received by the receiving unit; and
an imaging-processing apparatus that processes image data of the object obtained from the imaging unit such that the size of the object in the image based on the image data obtained from the imaging unit becomes a specified size, when it is determined that the transmitter is included in the image data.

38. The imaging apparatus of claim 37 further comprising
a size-identification unit that is operable to identify a size of the object in the image based on image data obtained by the imaging unit;
and wherein the image-processing unit processes the image data based on the size identified by the size-identification unit such that the size of the object in the image based on image data obtained from the imaging unit becomes a specified size.

39. A program that makes a computer operate as:
a judgment unit that is operable to determine whether or not a transmitter that transmits a object signal is included in an image based on image data obtained from a specified imaging unit when the object signal is received by a specified receiving unit; and
a recording unit that is operable to record object information, which is the content of the object signal, with the image data that is obtained from the imaging unit and with which the object information is associated when it is determined that the transmitter is included in the image.

40. A program that makes a computer operate as:
a search unit that is operable to search image data recorded by the recording unit of claim 39 for image data with which object information input by the user is associated; and
an extraction unit that is operable to extract the image data found by the search unit.

41. A program that makes a computer operate as:
a distance-identification unit that is operable to identify a distance between a transmitter that transmits an object signal and a specified imaging apparatus when the object signal is received by a certain receiving unit; and
an imaging unit that sets a focal distance when taking images of an object based on the distance identified by the distance-identification unit.

42. A program that makes a computer operate as:
a direction-identification unit that is operable to identify a direction of a transmission source of an object signal when the object signal is received by a certain receiving unit; and
a light-adjustment unit that is operable to control at least an amount of light emitted by a certain light-emitting unit, a direction of the light-emitting unit or a location of that light-emitting unit, such that the amount of light received from the direction identified by the direction-identification unit becomes a specified amount.

43. A program that makes a computer operate as:
a direction-identification unit that is operable to identify a direction of a transmission source of an object signal when the object signal is received by a certain receiving unit; and
an imaging-control unit that controls at least a direction or location of the imaging unit such that the amount of light received from the direction identified by the direction-identification unit becomes a specified amount.

44. A program that makes a computer operate as:
a direction-identification unit that is operable to identify a direction of a transmission source of an object signal when the object signal is received by a certain receiving unit; and
a light-adjustment unit that is operable to control an aperture such that the amount of light received from the direction identified by the direction-identification unit becomes a specified amount.

45. A program that makes a computer operate as:
a judgment unit that is operable to determine whether or not a transmitter that is attached to a certain object and transmits an object signal is included in an image based on image data obtained from a certain imaging unit when the object signal is received from a certain receiving unit;
an in-image-location-identification unit that is operable to identify a location of the object in the image based on the image data obtained from the imaging unit;
a size-identification unit that is operable to identify a size of the object in the image based on the image data obtained from the imaging unit; and
a contrast-adjustment unit that is operable to identify a range occupied by the object in the image based on the location identified by the in-image-location-identification unit and size identified by sad size-identification unit and adjust contrast of the image in that range, when the judgment unit determines that the transmitter is included in the image.

46. A program that makes a computer operate as:
a judgment unit that is operable to determine whether or not a transmitter that transmits an object signal is included in an image obtained from a certain imaging unit when the object signal is received by a certain receiving unit; and
an imaging unit that is operable to take images of an object when the transmitter is included in the image.

47. A program that makes a computer operate as:
a direction-identification unit that is operable to identify a direction of a transmission source of an object signal when the object signal is received by a certain receiving unit; and
an imaging-control unit that is operable to control at least a location or direction of the imaging unit such that a location of a transmitter that transmits the object signal is located in the center of an area whose image is taken based on the direction identified by the direction identification unit.

48. A program that makes a computer operate as:
a judgment unit that is operable to determine whether or not a transmitter that is attached to a certain object and transmits an object signal is included in an area whose image is taken when the object signal is received by a certain receiving unit; and
an imaging unit that is operable to control an imaging range when the transmitter is included in the area such that a size of the object in an image taken when image of the area is taken becomes a specified size.

49. A program that causes a computer operate as:
a judgment unit that is operable to determine whether or not the transmitter that is attached to a certain object and transmits an object signal is included in the area whose image is taken when the object signal is received by a certain receiving unit; and
an image-processing unit that is operable to process the image data of images taken such that the size of the object in the image based on the image data taken when images of the area are taken becomes a specified size when the transmitter is included in the area.

50. A program that makes a computer operate as:
an imaging unit;
a receiving unit that is operable to receive an object signal from outside;
a judgment unit that is operable to determine whether or not a location of a transmitter that transmits the object signal received by the receiving unit is included in image data obtained by the imaging unit;
a recording unit that is operable to record object information included in the object signal when the transmitter is included in the image data, with the image data that is obtained from the imaging unit and with which the object information is associated; and
a unit that is operable to send image data recorded by the recording unit and object information associated with that image data via a network.

51. A program that makes a computer operate as:
a unit that is operable to acquire image data and object information associated with that image data of claim 50 via a network; and
a unit that is operable to display image data based on the acquired object information.

52. A program that makes a computer operate as:
an imaging unit;
a receiving unit that is operable to receive an object signal from outside;
a judgment unit that is operable to determine whether or not a location of a transmitter that transmits the object signal that is received by the receiving unit is included in image data obtained from the imaging unit;
a recording unit that is operable to record object information that is included in the object signal, with the image data that is obtained from the imaging unit and with which the object information is associated when the transmitter is included in the image data;
a unit that is operable to acquire image data recorded by the recording unit and object information that is associated with that image data via a network;
a search unit that searches the acquired image data for image data with which object information that corresponds with a terminal to which images are distributed via a network is associated; and
an extraction unit that is operable to extract the image data found by the search unit.

53. Data that comprises:
image data representing a moving images having a plurality of frames and taken by an imaging unit; and
object information that is used by a computer to extract image data based on search results;
and wherein has a structure that associates the object information included in an object signal from a transmitter that is located within an image of a frame with the frame.

54. A computer readable recording medium on which the data of claim 53 is recorded.
